(19) United States
(12) Patent Application Publication
(10) Pub. No.: US 2025/0056321 A1
(43) Pub. Date: Feb. 13, 2025

(54) RADIO BEARER IDENTIFIER ASSIGNMENT IN RADIO PROTOCOL ARCHITECTURES FOR CELL-FREE NETWORKS

(71) Applicant: APPLE INC., Cupertino, CA (US)

(72) Inventors: Ahmed Gamal Helmy Mohamed, Cupertino, CA (US); Norman Goris, Munich (DE); Danila Zaev, Munich (DE); Firouz Behnamfar, Los Gatos, CA (US); Ayman F. Naguib, Cupertino, CA (US)

(21) Appl. No.: 18/797,299

(22) Filed: Aug. 7, 2024

Related U.S. Application Data
(60) Provisional application No. 63/518,642, filed on Aug. 10, 2023.

(51) Int. Cl. H04W 28/08; H04L 5/00; H04W 74/0833; H04W 76/15

(52) U.S. Cl. CPC H04W 28/0867; H04L 5/0055; H04W 76/15; H04W 74/0833

(57) ABSTRACT

Systems and methods for radio protocol architectures in cell-free networks are disclosed herein. One or more base stations make up a cell-free cluster that serves a user equipment (UE). A clustering control function (CCF) may establish, for a radio bearer that communicates data between the cluster and the UE, one or more sub-clusters of the one or more base stations. Each sub-cluster corresponds to a unique RLC entity within the protocol stack for the radio bearer in question. The CCF communicates with the base stations of the cluster and the UE to establish this sub-clustering arrangement. Details of this messaging are described herein. Data of the radio bearer is then transmitted between the cluster and the UE according to the established sub-clusters/RLC entities. For example, the network may transport either the same data of the radio bearer and/or unique data of the radio bearer through any/each of the sub-clusters/RLC entities.

### TECHNICAL FIELD

This application relates generally to wireless communication systems, including radio protocol architectures of cell-free networks.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for an example of clustering in a cell-free network architecture, according to embodiments discussed herein.

FIG. 2A illustrates a flow diagram for protocol stack configuration as between a UE and a base station.

FIG. 2B illustrates a diagram showing the relation between a QoS requirement, a radio bearer configuration, and a protocol stack architecture.

FIG. 3 illustrates a cluster for a UE that is partitioned into sub-clusters, according to embodiments herein.

FIG. 4 illustrates a diagram showing aspects of radio protocol use in cell-free network mechanisms, according to embodiments discussed herein.

FIG. 5A illustrates a radio protocol stack defined for a first radio bearer between a network and a UE according to the use of sub-clustering, according to embodiments herein.

FIG. 5B illustrates a network topology corresponding to the radio protocol stack of FIG. 5A, including the physical representation of the cluster (corresponding to the network of FIG. 5A) and a physical representation of the UE.

FIG. 6 illustrates a table illustrating various examples of messaging that may be exchanged for cluster partitioning, according to embodiments discussed herein.

FIG. 7 illustrates a flow diagram for elements of a cluster partitioning procedure, according to embodiments discussed herein.

FIG. 8A illustrates an example of the use of a PDCP Duplicated Packet Mode with a radio protocol stack for a radio bearer between a cluster and a UE according to the use of sub-clustering, corresponding to embodiments discussed herein.

FIG. 8B illustrates an example of the use of a PDCP Distinguished Packet Mode with the radio protocol stack that is arranged as in FIG. 8A.

FIG. 9 illustrates a table illustrating various examples of messaging that may be exchanged for cluster partitioning, according to embodiments discussed herein.

FIG. 10 illustrates a flow diagram for elements of a radio bearer configuration procedure, according to embodiments discussed herein.

FIG. 11 illustrates an example of a cell-agnostic radio protocol architecture and an example of a cell-aware radio protocol architecture.

FIG. 12 illustrates an example of the use of a PDCP Duplicated Packet Mode with a radio protocol stack for a radio bearer between a cluster and a UE according to the use of sub-clustering, where the radio protocol stack is arranged according to a cell-agnostic radio protocol architecture, corresponding to embodiments discussed herein.

FIG. 13A illustrates an example of the use of a PDCP Distinguished Packet Mode with a radio protocol stack for a radio bearer between a cluster and a UE according to the use of sub-clustering, where the radio protocol stack is arranged according to a cell-aware radio protocol architecture, corresponding to embodiments discussed herein.

FIG. 13B illustrates an example of the use of a PDCP Duplicated Packet Mode with a radio protocol stack for a radio bearer between a cluster and a UE according to the use of sub-clustering, where the radio protocol stack is arranged according to a cell-aware radio protocol architecture, corresponding to embodiments discussed herein.

FIG. 14 illustrates an example of packet routing though a radio protocol stack for a radio bearer between a cluster and a UE according to the use of sub-clustering, where the radio protocol stack is arranged according to a cell-aware radio protocol architecture, corresponding to embodiments discussed herein.

FIG. 15 illustrates a diagram showing aspects of radio protocol use in cell-free network mechanisms, according to embodiments discussed herein.

FIG. 16 illustrates a method of a CCF of a wireless communication system, according to embodiments discussed herein.

FIG. 17 illustrates a method of a CCF of a wireless communication system, according to embodiments discussed herein.

FIG. 18 illustrates a method of a base station of a cluster of base station of a wireless communication system that is serving a UE, according to embodiments discussed herein.

FIG. 19 illustrates a method of a UE served by a cluster of base stations of a wireless communication system, according to embodiments discussed herein.

FIG. 20 illustrates a method of a CCF of a wireless communication system, according to embodiments discussed herein.

FIG. 21 illustrates a method of a CCF of a wireless communication system, according to embodiments discussed herein.

FIG. 22 illustrates a method of a base station of a cluster of base stations of a wireless communication system that is serving a UE and that is operating in a first sub-cluster of a plurality of sub-clusters of the cluster that is for a plurality of the base stations of the cluster and that corresponds to a first RLC entity, according to embodiments discussed herein.

FIG. 23 illustrates a method of a UE served by a cluster of base stations of a wireless communication system and that uses a first RLC entity of the cluster that corresponds to a first sub-cluster of a plurality of sub-clusters of the cluster that is for a plurality of the base stations of the cluster, according to embodiments discussed herein.

FIG. 24 illustrates a method of a PDCP entity of a cluster of base stations serving a UE, according to embodiments discussed herein.

FIG. 25 illustrates an example architecture of a wireless communication system, according to embodiments disclosed herein.

FIG. 26 illustrates a system for performing signaling between a wireless device and a network device as supported by a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Clustering in Cell-Free Networks

In some wireless communication systems, a cell-free network architecture provides an adaptive/dynamic and UE-centric distribution of functionalities that may be associated with a “serving cell” as understood in the context of prior cell-based network architectures (e.g., such as an NR network architecture or an LTE network architecture). With respect to the present disclosure, it may be understood generally that a “cluster” or “serving cluster” of a UE is a set of physically and/or logically connected base stations over which functionalities related to the serving the UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

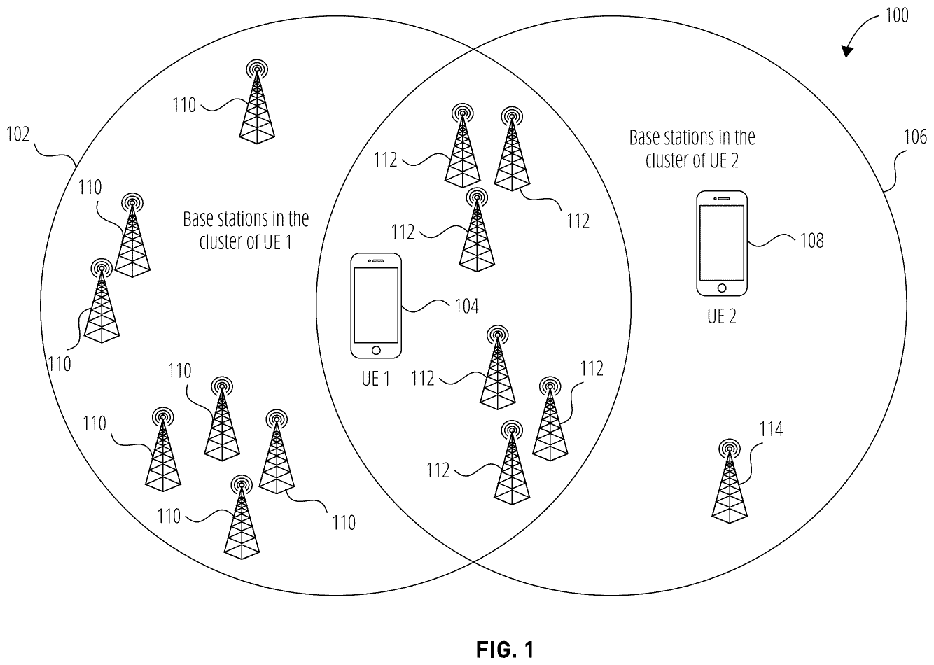

FIG. 1 illustrates a diagram 100 for an example of clustering in a cell-free network architecture, according to embodiments discussed herein. A first cluster 102 of base stations serves a first UE 104 and a second cluster 106 of base stations serves the second UE 108. As illustrated, the first cluster 102 includes the first base stations 110 and the second base stations 112, while the second cluster 106 includes the second base stations 112 and the third base station 114.

Base stations in a same cluster are not necessarily required to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core network, a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QOS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE's initial access). These may include, for example, “greedy”, downlink (DL)-based, uplink (UL)-based, and/or real-time methodologies (and any corresponding message exchanges).

### Radio Bearers and Protocol Stacks

In some wireless communication systems, data may be transmitted over one or more radio bearers between the UE and its serving base station(s). Each radio bearer may be associated with a packet data convergence protocol (PDCP) entity, a radio link control (RLC) entity, and a medium access control (MAC) entity(s). The PDCP entity may be configured to route packets to any corresponding RLC entities based on a radio bearer identifier (ID). It may accordingly be understood that when the PDCP entity is to transmit a packet, it may forward the packet to the appropriate RLC entity based on a radio bearer ID and a logical channel associated with the transmission.

The process of radio bearer ID assignment and configuration may occur during an initial connection setup between the UE and the base station, and/or may occur when there is a change in the quality of service (QOS) requirements.

The base station may send the radio bearer configuration information to the UE through radio resource control (RRC) signaling message(s). The radio bearer configuration information may include, for one or more radio bearers, a radio bearer ID and associated PDCP, RLC, and MAC entity configurations.

The UE may then configure its protocol stack based on the received radio bearer configuration information by establishing the corresponding/indicated PDCP, RLC, and MAC entities for each radio bearer that is configured. Once a radio bearer is established, a UE and a base station may exchange data over that radio bearer according to the corresponding QoS requirements.

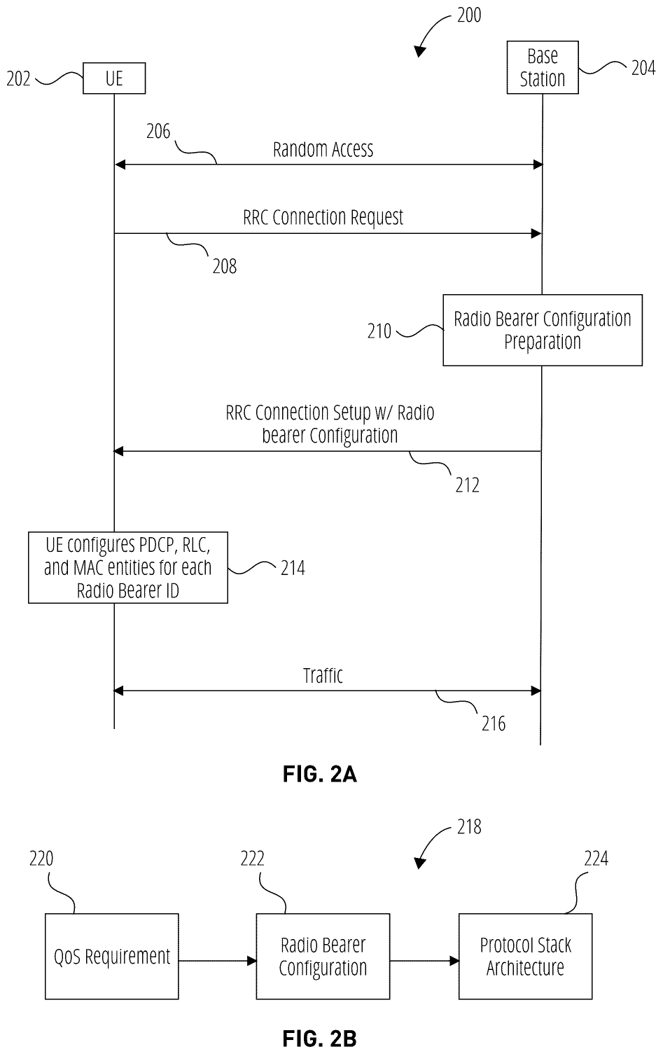

FIG. 2A illustrates a flow diagram 200 for protocol stack configuration as between a UE 202 and a base station 204. The UE 202 and the base station 204 perform a random access procedure 206. As a result of performing the random access procedure 206, the UE 202 sends an RRC connection request 208 to the base station 204.

The base station 204 then perform the radio bearer configuration preparation 210. As part of the radio bearer configuration preparation 210, corresponding PDCP, RLC, and MAC entities are assigned to each of one or more radio bearers within radio bearer configuration information.

The base station 204 then sends the UE 202 an RRC connection setup message 212 that includes the radio bearer configuration information. The UE 202 then proceeds to accordingly configure 214 PDCP, RLC, and MAC entities for each of the one or more radio bearers, as indicated in the radio bearer configuration information. The UE 202 and the base station 204 then proceed to communicate traffic 216 using the one or more radio bearers.

FIG. 2B illustrates a diagram 218 showing the relation between a QoS requirement 220, a radio bearer configuration 222, and a protocol stack architecture 224. As illustrated, it may be that a QoS requirement 220 imposes the use of a particular radio bearer configuration 222. The radio bearer configuration 222 in turn imposes particular aspects of a protocol stack architecture 224 that is to be used.

### Effects of Clustering on Radio Protocol Architecture

Given the use of clustering in a cell-free network, where traditional serving cell functionality is distributed across a set of base stations, various aspects with respect to radio protocol architecture setup and use at the network and/or the UE may be considered. Such issues include: mechanisms to define a cluster partitioning procedure that provides logical partitions of a UE-specific cluster for each radio bearer defined by QoS requirements; mechanisms to define the use of a sub-cluster within the radio protocol architecture in cell-free networks; mechanisms for various sub-cluster operations, including RLC synchronization mechanisms and/or radio protocol stack mechanisms; mechanisms for functionalities of cluster partitioning procedures used by a CCF; mechanisms for RRC messaging exchanges and protocols for a cluster partitioning procedure; mechanisms for PDCP data routing operational modes (e.g., a PDCP Duplicated Packet Mode and/or a PDCP Distinguished Packet Mode); mechanisms for radio bearer configuration and ID assignment in cell-free networks in a way that is associated with the definition for a sub-cluster; mechanisms for triggers and UE/network functionalities for radio bearer configuration and ID assignment; and/or mechanisms for RRC messaging exchanges and protocols for radio bearer configuration and ID assignment.

### Cluster Partitioning-Protocol Architecture

A cluster partitioning procedure provides logical partitions of a UE-specific cluster of base stations into sub-clusters. Accordingly, a sub-cluster may be understood as a logical building block of the UE-specific cluster of base stations.

In embodiments of cell-free networks, for each radio bearer defined according QoS requirements used in a cluster, a corresponding protocol stack architecture may be provisioned on a sub-cluster basis. Accordingly, a sub-cluster may be understood as a subset of base stations of the UE-specific cluster that share the same protocol stack architecture for a given radio bearer from the UE perspective.

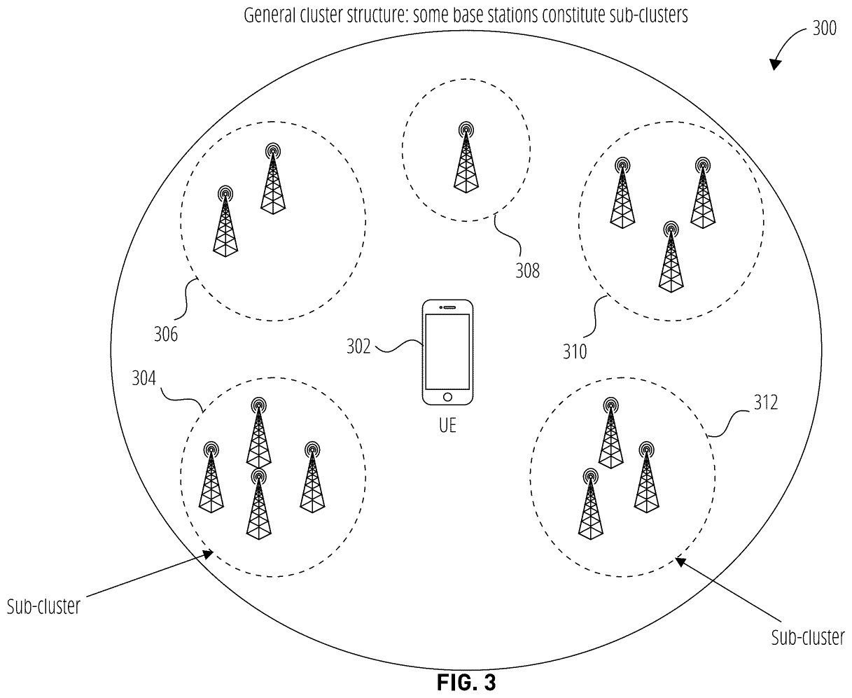

FIG. 3 illustrates a cluster 300 for a UE 302 that is partitioned into sub-clusters, according to embodiments herein. A cluster partitioning procedure has partitioned the cluster 300 into the first sub-cluster 304, the second sub-cluster 306, the third sub-cluster 308, the fourth sub-cluster 310, and the fifth sub-cluster 312, as illustrated. It will be appreciated that there is no overlap between the various sub-clusters. This is because each base station of the cluster 300 can belong to one sub-cluster of the cluster 300 corresponding to the use of a radio bearer between the UE 302 and the cluster 300. Note, however, that there is no restriction on any base station within any sub-cluster as illustrated here simultaneously operating in a different sub-cluster used with respect to another radio bearer between the UE 302 and the cluster 300 as may exist (but note that only the sub-clustering for a single radio bearer is expressly illustrated in FIG. 3).

In embodiments herein, various feature(s) related to the use of sub-clustering on a radio bearer basis may include that: a UE-specific cluster may consist of a single sub-cluster or multiple sub-clusters; the internal structure of sub-cluster (which base stations belong to a sub-cluster) may be transparent for the UE; and/or that from the protocol stack architecture perspective, the UE may consider a sub-cluster as a single entity (corresponding to a single protocol stack at the UE side).

Base stations of a same sub-cluster may use RLC synchronization. In one example of RLC synchronization, base stations within a same sub-cluster may be assumed to operate identical copies or instances of a same logical RLC entity (e.g., with the same RLC IDs, and/or same RLC operation modes) and to receive and process corresponding traffic from PDCP accordingly.

In a second example of RLC synchronization, it may be assumed that base stations within a same sub-cluster share a single instance of a logical RLC entity. In some such cases, a base station of a sub-cluster that does not presently have the RLC entity may send its traffic to the base station of the sub-cluster having the RLC entity for RLC layer processing purposes. In some such cases, it may be that the single logical RLC entity is transferrable, where a receiving base station may receive the RLC entity from a transferring base station to thereby enable it to perform RLC layer processing for the sub-cluster.

Herein, the use of RLC entity instance(s) according to either one of these examples of RLC synchronization may be sometimes more simply referred to as the use of “synchronized RLC entities” or the like.

In applicable embodiments herein, instances of RLC entities for base stations within the same sub-cluster may be assumed to be fully synchronized to have an identical RLC buffer status. Further, any information changes (for example RLC data removal for any reason) are conveyed to all identical instances of RLC entities for base stations within the same sub-cluster.

### Sub-Cluster Based Protocol Architecture at the RLC Layer

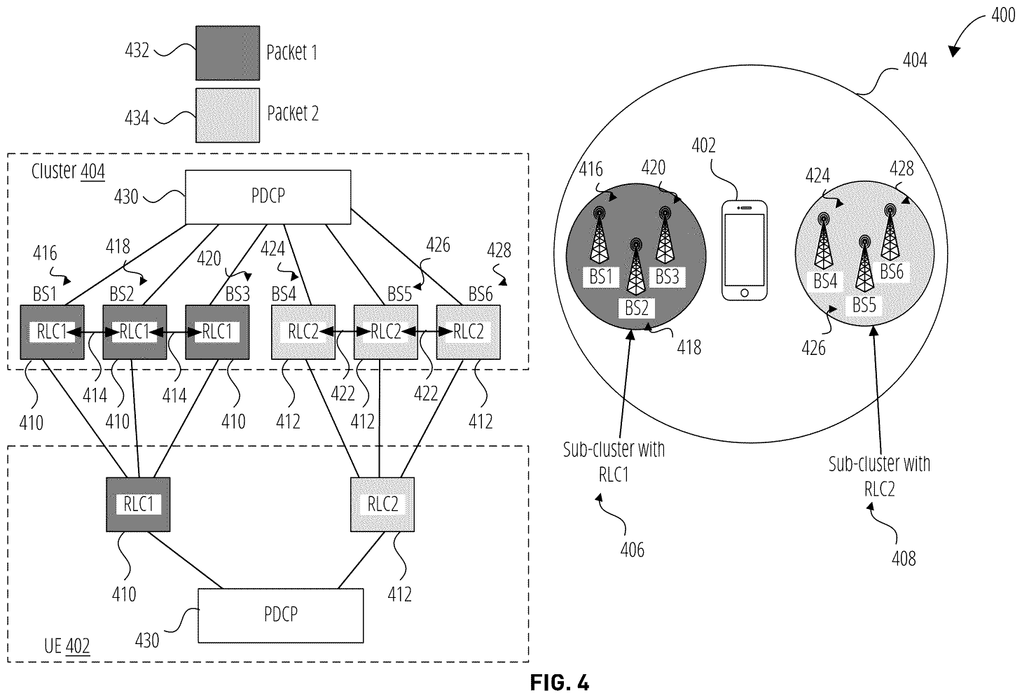

FIG. 4 illustrates a diagram 400 showing aspects of radio protocol use in cell-free network mechanisms, according to embodiments discussed herein. A UE 402 is served by a cluster 404. Within the cluster 404, there is a first sub-cluster 406 that corresponds to a first RLC entity 410 used between the UE 402 and the cluster 404 and a second sub-cluster 408 that corresponds to a second RLC entity 412 between the UE 402 and the cluster 404. The first RLC entity 410 and the second RLC entity 412 are RLC entities used by a PDCP entity 430 that corresponds to a radio bearer between the UE 402 and the cluster 404 and that uses the illustrated cluster partitioning.

As illustrated, the first RLC entity 410 is synchronized 414 across the base stations of the first sub-cluster 406 (the first base station 416 (BS1), the second base station 418 (BS2), and the third base station 420 (BS3)). For example, it may be that each of the first base station 416, the second base station 418, and the third base station 420 has and operates according to an instance of the first RLC entity 410. Further, the second RLC entity 412 is synchronized 422 across the base stations of the second sub-cluster 408 (the fourth base station 424 (BS4), the fifth base station 426 (BS5), and the sixth base station 428 (BS6)). This means that, for example, each of the fourth base station 424, the fifth base station 426, and the sixth base station 428 has and operates according to an instance of the second RLC entity 412, as shown. Note that, as illustrated, the arrangement of particular base stations of the cluster into the first sub-cluster 406 or second sub-cluster 408 may be transparent to the UE (the UE knows about/operates in terms of the first RLC entity 410 and the second RLC entity 412 (in terms of the sub-clusters), without consideration with respect to particular base stations underlying those RLC entities/sub-clusters).

In the illustrated case, a first packet 432 of the radio bearer corresponding to the PDCP entity 430 is handled at the first RLC entity 410. This ultimately means that the first packet 432 is communicated between the UE 402 and the cluster 404 via one or more of the base stations of the first sub-cluster 406. Further, a second packet 434 of the (same) radio bearer corresponding to the PDCP entity 430 is handled at the second RLC entity 412. This ultimately means that the second packet 434 is communicated between the UE 402 and the cluster 404 via one or more of the base stations of the second sub-cluster 408.

In FIG. 4, the first RLC entity 410 (RLC1) may be understood to be identical at each applicable base station (BS1, BS2 and BS3, as illustrated), and thus any of those base stations are eligible to receive the first packet 432. Further, the states of the RLC1 buffer at each of BS1, BS2, and BS3 may be fully identical. The PDCP entity 430 may route the same traffic (e.g., the first packet 432) to the RLC1 of BS1, BS2, and BS3.

Further, the second RLC entity 412 (RLC2) may be understood to be identical at each applicable base station (BS4, BS5 and BS6, as illustrated), and thus any of those base stations are eligible to receive the second packet 434. Further, the states of the RLC2 buffer at each of BS4, BS5, and BS6 may be fully identical. The PDCP entity 430 may route the same traffic (e.g., the second packet 434) to the RLC2 of BS4, BS5, and BS6.

Note also that each of the first sub-cluster 406 and the second sub-cluster 408 is visible to the UE (as the UE has visibility to/uses each of first RLC entity 410 and the second RLC entity 412 corresponding to these sub-clusters, as illustrated in FIG. 4). However, the internal structure of each of the first sub-cluster 406 and the second sub-cluster 408 (in terms of which base stations of the cluster 404 are included in the first sub-cluster 406 or the second sub-cluster 408) is transparent to the UE.

It is contemplated that a cluster partitioning may be updated over time. Establishment and/or updating of a cluster partitioning may take into account QoS requirements and traffic properties associated with a radio bearer. For example, latency constraints, and/or traffic periodicity may be considered. These mechanisms allow the network (e.g., a CCF) to optimally configure sub-cluster-enabled multi-connectivity of a UE to a cluster in, for example, a non-ideal backhaul scenario (where different partitionings of a same cluster may have appreciably different QoS/traffic management characteristics).

In some wireless communication systems, radio protocols in cell-free networks utilize concepts such as cluster partitioning/sub-clusters, RLC synchronization, etc. A functionality for control over dynamically updating cluster partitions, and a corresponding protocol for the update procedure, may be used. PDCP data routing options and a corresponding configuration may be used. Finally, a cell-free radio bearer configuration and/or a message exchange procedure for radio bearer establishment may be used.

### Sub-Cluster Based Protocol Architecture-Radio Protocol Stack

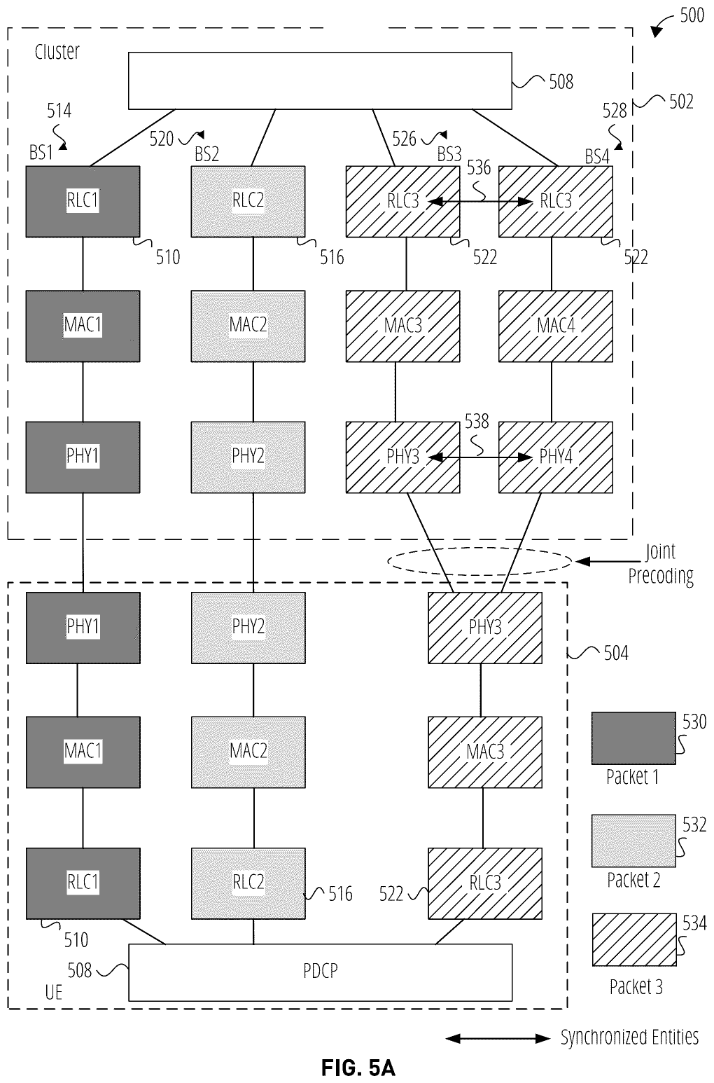

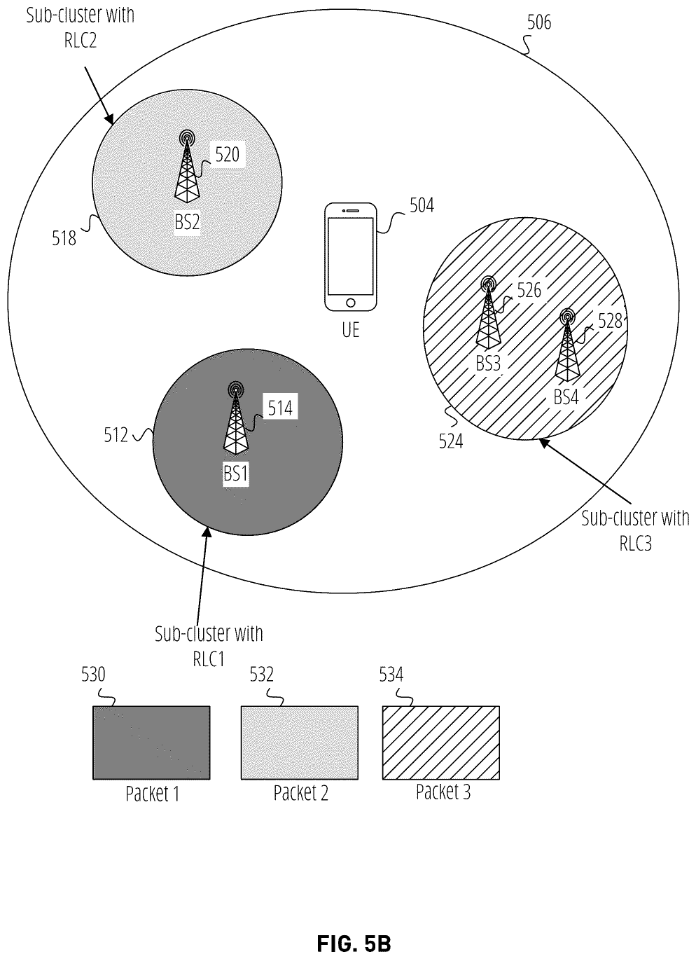

According to various embodiments, radio protocol stacks may be defined with respect to each radio bearer. FIG. 5A illustrates a radio protocol stack 500 defined for a first radio bearer between a network 502 and a UE 504 according to the use of sub-clustering, according to embodiments herein. FIG. 5B illustrates a network topology corresponding to the radio protocol stack of FIG. 5A, including the physical representation of the cluster 506 (corresponding to the network 502 of FIG. 5A) and a physical representation of the UE 504.

As illustrated, within the radio protocol stack 500 there is a PDCP entity 508 corresponding to the radio bearer. Beneath the PDCP entity 508, there is a first RLC entity 510 corresponding to a first sub-cluster 512 made up of a first base station 514 (BS1), a second RLC entity 516 corresponding to a second sub-cluster 518 made up of a second base station 520 (BS2), and a third RLC entity 522 corresponding to a third sub-cluster 524 made up of a third base station 526 and a fourth base station 528.

As illustrated in FIG. 5A, the third base station 526 and the fourth base station 528 of the third sub-cluster 524 are synchronized 536 with respect to the third RLC entity 522, meaning that the RLC entity instances as understood at each of the third base station 526 and the fourth base station 528 are identical instances of the third RLC entity 522 and/or that each of the third base station 526 and the fourth base station 528 use the same (single) instance of the third RLC entity 522 for traffic routing, as described elsewhere herein. Note that, as illustrated, no matter the situation with the third RLC entity 522 at the network 502, the UE 504 uses/understands a single third RLC entity 522 (any reproduction and/or sharing of the third RLC entity 522 as between the third base station 526 and the fourth base station 528 at the network 502 is transparent to the UE 504).

A PDCP entity may be assumed to route the same data traffic of the data bearer to all synchronized RLC entities at the network side. For example, as illustrated in FIG. 5A, the same third packet 534 is routed to each copy of the third RLC entity 522 used at the network 502 at each of the third base station 526 and/or the fourth base station 528.

On the other hand, base stations of different sub-clusters for the same PDCP entity do not use (or at least do not require the use of) synchronized RLC entities. The PDCP entity may accordingly not be required and/or necessarily expected to route the same data traffic across non-synchronized RLC entities. For example, as illustrated in FIG. 5A, the first packet 530 is routed to the first RLC entity 510 at the first base station 514, the second packet 532 is routed to the second RLC entity 516 at the second base station 520, and the third packet is routed to the third RLC entity 522 at each of the third base station 526 and the fourth base station 528 (as previously discussed).

It may be that when there are multiple base stations within a same sub-cluster, they are assumed to use a synchronized PHY entity in cases of joint precoding. For example, FIG. 5A illustrates that the third base station 526 and the fourth base station 528 of the third sub-cluster 524 are synchronized 538 across their respective PHY entities with respect to a joint precoding case.

### Functionalities of CCF for Cluster Partitioning

In various embodiments, a CCF may perform any one or more of a variety of operations for any radio bearer within any cluster controlled by the CCF. These operations include but are not limited to: dynamically conducting a cluster partitioning procedure that logically provides partitions of a cluster into sub-clusters for each radio bearer defined by QoS requirements; form a connected set of sub-clusters by logically connecting subsets of base stations of the cluster to share a same protocol stack architecture; update the connected set of sub-clusters by modifying, adding, and/or removing sub-clusters and/or modifying, adding, and/or removing base stations in one or more sub-clusters; configuring PDCP, RLC, and MAC entity configurations corresponding to any sub-cluster; validating RLC synchronization requirements and/or configurations that correspond to a given sub-cluster; keeping connected sets of sub-clusters updated corresponding to at any given time; and/or communicating updated sub-clusters (and their associated PDCP, RLC, and MAC entity configurations) to corresponding network elements via an appropriate interface.

In various embodiments, the CCF may have the ability to form and/or update a connected set of sub-clusters based on any combination of one or more of the following: feedback from connected UE(s) and/or any updated information on mobility, environment, measured interference, and/or traffic/QoS requirements; RLC synchronization changes reported by any base station(s) within a given sub-cluster; a UE request/proposal for base station(s) to add to and/or remove from a given sub-cluster; a message indicating that a UE accepts and/or rejects addition and/or removal of base station(s) to a given sub-cluster; a base station request/proposal for base station(s) to add to and/or remove from a given sub-cluster (including but not limited to itself); a message indicating that a base station accepts and/or rejects addition and/or removal of base station(s) to a given sub-cluster (including but not limited to itself).

### Cluster Partitioning Messaging Exchange Types

In some embodiments, with respect to each radio bearer in use, it may be that the CCF is able to either directly or indirectly exchange messages with any base station(s) within a cluster via an appropriate interface. It may be that the CCF is able to either directly or indirectly exchange messages with the UE served by the cluster via an appropriate interface. It may be that all base stations that belong to the cluster are able to exchange messages among themselves using, for example, Xn interface(s). It may be that the UE supports the application/use of an RRC connection with the network and is not dependent on any one connection with any particular base station. It may therefore accordingly be that a cluster and/or sub-cluster update procedure does not require the use of any RRC connection reestablishment mechanism.

Corresponding to embodiments discussed herein, there may be various possible types of messages that are used between/among the CCF, the base station(s), and/or the UE to perform dynamic coordination, communication, and processing of cluster partitioning procedures.

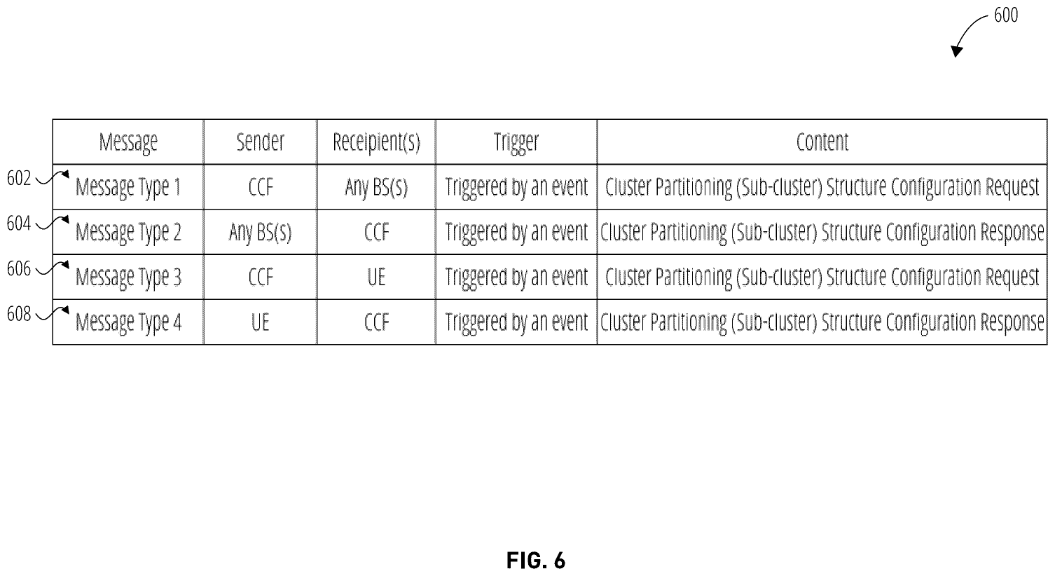

FIG. 6 illustrates a table 600 illustrating various examples of messaging that may be exchanged for cluster partitioning, according to embodiments discussed herein. The table 600 illustrates a first message type 602 that may be used. As illustrated, the first message type 602 may be sent by a CCF and received by any base station within a cluster. The first message type 602 may be triggered by an event. The first message type 602 may include a cluster partitioning (e.g., sub-clustering) structure configuration request.

Messages of the first message type 602 may be used by the CCF to request that any base station configure and/or update its cluster partitioning structure (e.g., to join and/or leave a given sub-cluster). Messages of the first message type 602 may be triggered based on a preconfigured event (e.g., a QoS requirement change). Messages of the first message type 602 may be sent to any base station that belongs to an applicable cluster for the UE. Messages of the first message type 602 may include any one or more of the following contents: a request ID that identifies the clustering partitioning configuration request; a cluster ID for the cluster in question; one or more clustering partitioning (e.g., sub-clustering) structure configurations, such as sub-clusters ID and associated characteristics; and/or UE context information which may include any one or more of a variety of information items (e.g., a UE RRC status, a UE RRM configuration indicating various UE inactive times, a QoS flow to DRB mapping, information about UE capabilities for different RAT(s), an RLC buffer status report for the UE corresponding to an active time, PDU session information, and/or and network slice information).

The table 600 further illustrates a second message type 604 that may be used. As illustrated, the second message type 604 may be sent by a base station within a cluster and received by the CCF. The second message type 604 may be triggered by an event. The second message type 604 may include a cluster partitioning (e.g., sub-clustering) structure configuration response that is provided to the CCF in reply to a cluster partitioning structure configuration request received at the base station.

Messages of the second message type 604 may be used by base stations to respond to a request from a CCF to configure their clustering partitioning (e.g., sub-cluster) structures (e.g., in response to a message of a first message type 602 from the CCF). Messages of the second message type 604 may be triggered based on a pre-configured event (e.g., a QoS requirement change). Messages of the second message type 604 may be sent to the CCF. Messages of the second message type 604 may include any one or more of the following contents: a request ID that identifies the corresponding cluster partition reconfiguration request (e.g., as received in that cluster partition reconfiguration request), a cluster ID for the cluster in question; a sub-cluster ID, and/or a clustering partitioning (e.g., sub-clustering) structure configurations response (e.g., that includes an acknowledgment and/or negative acknowledgment for the corresponding cluster partition reconfiguration request).

The table 600 further illustrates a third message type 606 that may be used. As illustrated, the third message type 606 may be sent by a CCF and received by a UE. The third message type 606 may be triggered by an event. The third message type 606 may include a cluster partitioning (e.g., sub-clustering) structure configuration request.

Messages of the third message type 606 may be used by the CCF to request that a UE configure and/or update its cluster partitioning structure (e.g., the UE's understanding of the protocol stacks to use for communication within the cluster). Messages of the third message type 606 may be triggered based on a preconfigured event (e.g., a QoS requirement change). Messages of the third message type 606 may be sent to the UE being served by the applicable cluster. Messages of the third message type 606 may include any one or more of the following contents: a request ID that identifies the clustering partitioning configuration request; a cluster ID for the cluster in question; one or more clustering partitioning (e.g., sub-clustering) structure configurations, such as sub-clusters ID and associated characteristics; and/or UE context information which may include any one or more of a variety of information items (e.g., a UE RRC status, a UE RRM configuration indicating various UE inactive times, a QoS flow to DRB mapping, information about UE capabilities for different RAT(s), an RLC buffer status report for the UE corresponding to an active time, PDU session information, and/or and network slice information).

The table 600 further illustrates a fourth message type 608 that may be used. As illustrated, the fourth message type 608 may be sent by a UE and received by the CCF. The fourth message type 608 may be triggered by an event. The fourth message type 608 may include a cluster partitioning (e.g., sub-clustering) structure configuration response that is provided to the CCF in reply to a cluster partitioning structure configuration request received at the UE.

Messages of the fourth message type 608 may be used by UEs to respond to a request from a CCF to configure their clustering partitioning (e.g., sub-cluster) structures (e.g., in response to a message of a third message type 606 from the CCF). Messages of the fourth message type 608 may be triggered based on a pre-configured event (e.g., a QoS requirement change). Messages of the fourth message type 608 may be sent to the CCF. Messages of the fourth message type 608 may include any one or more of the following contents: a request ID that identifies the corresponding cluster partition reconfiguration request (e.g., as received in that cluster partition reconfiguration request), a cluster ID for the cluster in question; a sub-cluster ID, and/or a clustering partitioning (e.g., sub-clustering) structure configurations response (e.g., that includes an acknowledgment and/or negative acknowledgment for the corresponding cluster partition reconfiguration request).

### Example Cluster Partitioning Message Types Flow

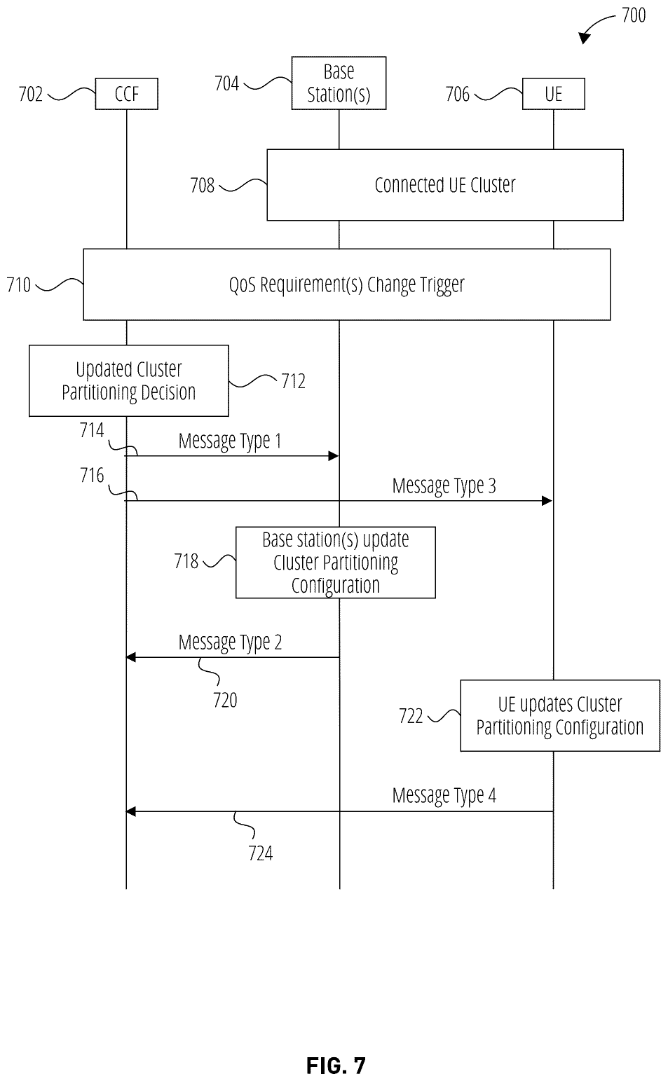

FIG. 7 illustrates a flow diagram 700 for elements of a cluster partitioning procedure, according to embodiments discussed herein. The flow diagram 700 illustrates communications between a CCF 702, base station(s) 704, and a UE 706.

The beginning of the flow diagram 700 corresponds to a state where a connected UE cluster 708 exists. For example, it may be that the CCF 702 has already formulated a cluster for the UE 706 made up of the base station(s) 704.

Then, a QoS requirement(s) change trigger 710 is recognized within the system. In response to the QoS requirement(s) change trigger 710, a cluster partitioning for the cluster is to be performed. Accordingly, the CCF 702 takes an updated cluster partitioning decision 712, as illustrated.

The CCF 702 then sends message(s) 714 of the first message type to the base station(s) 704, as illustrated. These message(s) 714 request each of the base stations to, for example, join, leave, and/or operate within a given sub-cluster(s), per the determination(s) made in the updated cluster partitioning decision 712.

The CCF 702 further sends message(s) 716 of the third message type to the UE 706, as illustrated. These message(s) 716 request the UE to configure and/or update its understanding of the protocol stacks to use for communication within the cluster to be consistent with the determination(s) made in the updated cluster partitioning decision 712.

In response to the message(s) 714, the base station(s) 704 update 718 their respective cluster partitioning configurations to be consistent with the information provided in the message(s) 714. The base station(s) 704 then send the CCF 702 message(s) 720 of the second message type. These message(s) 720 may acknowledge to the CCF 702 that the respective base stations have joined, left, and/or are operating within sub-clusters according to instructions in the message(s) 714, as the case may be.

In response to the message(s) 716, the UE 706 updates 722 its understanding of the protocol stacks to use (e.g., its understanding of RLC entity(s) to use) for communication within the cluster to be consistent with the determination(s) made in the updated cluster partitioning decision 712. The UE then sends the CCF 702 message(s) 724 of the fourth message type. These message(s) 724 may acknowledge to the CCF 702 that the UE 706 has updated its understanding of the protocol stacks to use for communication within the cluster to be consistent with the instructions found in the message(s) 716.

### Embodiments for PDCP Data Routing

Base stations of a same sub-cluster correspond to a synchronized RLC use for that sub-cluster. Either the base stations of the sub-cluster each use a same (e.g., identical) RLC entity, or a single RLC entity instance is shared between the base stations of the sub-cluster. In the case of the use of a same RLC entity at each of the base station, the corresponding RLC entity instances at each base station for same sub-cluster may be assumed to use an identical RLC buffer status, RLC ID, RLC operation mode, etc., and a PDCP entity may be assumed to duplicate and route the same data traffic (for example packets) to/through all base stations using the same RLC entity having instances using a same RLC ID. In the case of shared RLC entity use within/among the base stations of the sub-cluster, data traffic for the RLC entity may be duplicated and routed through each base station associated with the shared RLC entity. Finally, synchronized PHY entities may be assumed in such scenarios in case of the use of joint precoding between multiple base stations within a same sub-cluster.

Within this context, for each UE-specific cluster, one of two PDCP data routing modes may be utilized. Herein, these two modes may be referred to as “Mode 1” and “Mode 2,” respectively.

A Mode 1 for PDCP data routing may also be called a “PDCP Duplicated Packet Mode.” Mode 1 may be defined according to various characteristics. Under Mode 1, a PDCP entity may optionally duplicate and route the same data traffic (for example packets) to/through base stations of different sub-clusters synchronized to different RLC entities within the same cluster. In this case, RLC entities of base stations of differing sub-clusters are not required to be synchronized (e.g., RLC entities of base stations of different sub-clusters are not required to use an identical RLC buffer status, RLC ID, RLC operation mode, etc.), notwithstanding the fact that they are working with identical (duplicated) data. Mode 1 may provide relatively larger reliability gain over other possible modes.

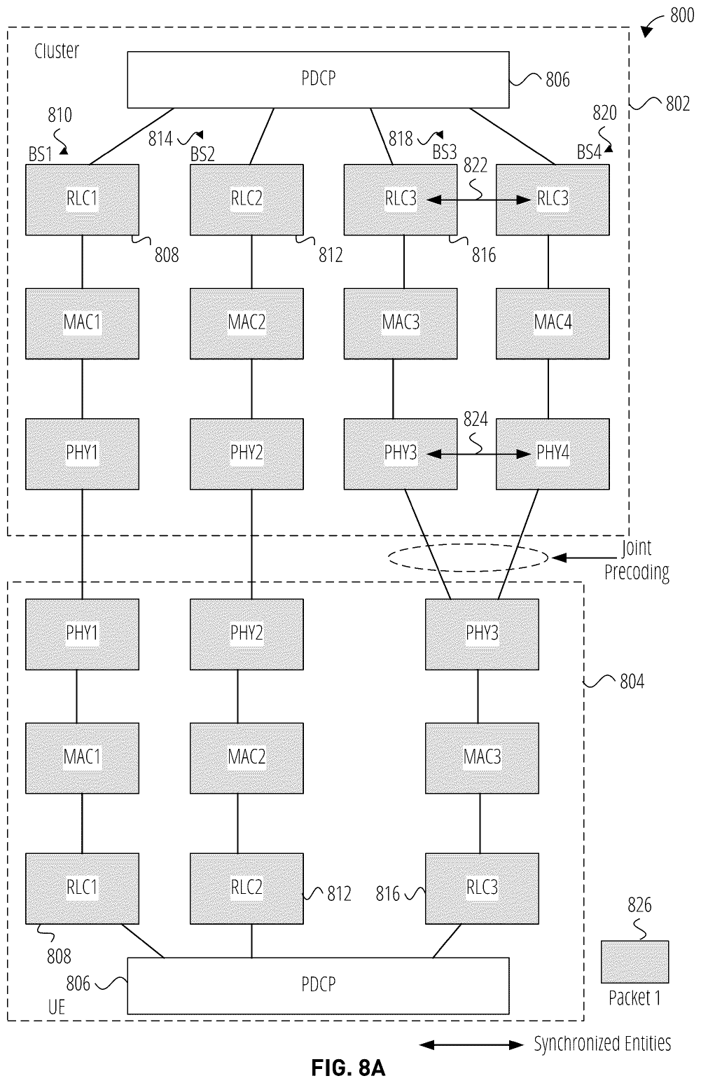

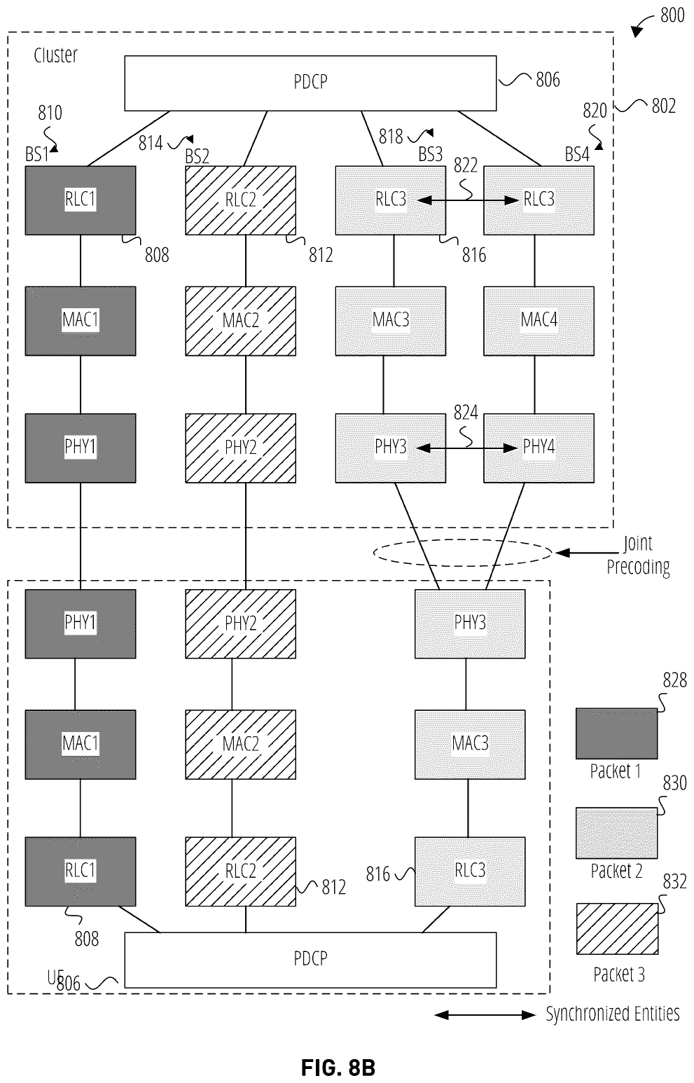

FIG. 8A illustrates an example of the use of a PDCP Duplicated Packet Mode with a radio protocol stack 800 for a radio bearer between a cluster 802 and a UE 804 according to the use of sub-clustering, corresponding to embodiments discussed herein. As illustrated, within the radio protocol stack 800 there is a PDCP entity 806 corresponding to the radio bearer. Beneath the PDCP entity 806, there is a first RLC entity 808 corresponding to a first sub-cluster made up of a first base station 810 (BS1), a second RLC entity 812 corresponding to a second sub-cluster made up of a second base station 814 (BS2), and a third RLC entity 816 corresponding to a third sub-cluster made up of a third base station 818 and a fourth base station 820.

As illustrated in FIG. 8A, the third base station 818 and the fourth base station 820 of the third sub-cluster are synchronized 822 with respect to the third RLC entity 816, meaning that the RLC entities as understood at each of the third base station 818 and the fourth base station 820 are identical copies of the third RLC entity 816 and/or that each of the third base station 818 and the fourth base station 820 use the same (single) copy of the third RLC entity 816 for traffic routing, as described elsewhere herein.

FIG. 8A further illustrates that the third base station 818 and the fourth base station 820 of the third sub-cluster are synchronized 824 across their respective PHY entities with respect to a joint precoding case.

In a PDCP Duplicated Packet Mode, duplicated packets may be routed to/through different RLC entities (through base stations belonging to the different sub-clusters represented by those different RLC entities). As illustrated in FIG. 8A, the duplicated packet 826 is duplicated and routed to/through each of the first RLC entity 808 (the first base station 810), the second RLC entity 812 (the second base station 814), and the third RLC entity 816 (the third base station 818 and the fourth base station 820).

A Mode 2 for PDCP data routing may also be called a PDCP Distinguished Packet Mode. Mode 2 may be defined according to various characteristics. Under Mode 2, a PDCP entity may route different data traffic (for example, different packets) to/through base stations of different sub-clusters synchronized to different RLC entities within the same cluster. Mode 2 may provide enhanced multiplexing gain over other possible modes.

FIG. 8B illustrates an example of the use of a PDCP Distinguished Packet Mode with the radio protocol stack 800 that is arranged as previously described in relation to FIG. 8A.

In a PDCP Distinguished Packet Mode, unique (e.g., independent and/or different) packets may be routed to/through different RLC entities (through base stations belonging to the different sub-clusters represented by those different RLC entities). As illustrated in FIG. 8B, the first unique packet 828 is routed to/through the first RLC entity 808 (the first base station 810), the second unique packet 830 is routed to/through the second RLC entity 812 (the second base station 814), and the third unique packet 832 is routed to/through the third RLC entity 816 (the third base station 818 and the fourth base station 820).

### Radio Bearer Configuration Messaging Exchange Types

In existing wireless systems, with respect to a radio bearer that is in use, a radio bearer configuration and ID assignment may be established between a UE and a base station. This radio bearer configuration/ID assignment may be associated with a specific PDCP entity. This configuration and assignment may be made to the UE by the base station at the initial access/access connection phase.

In embodiments corresponding to discussion herein, for a radio bearer that is in use, a radio bearer configuration and ID assignment may be established between a UE and a sub-cluster that is associated with a specific PDCP entity. This radio bearer configuration/ID assignment may be made to the UE by the network (for example, by the CCF) and may be communicated to the UE upon one or more event-based triggers.

Accordingly, in some embodiments, a radio bearer ID re-assignment procedure may be triggered based on any one or more of the following events: a clustering decision change at the network side (e.g., at the CCF); a sub-clustering decision change at the network side (e.g., at the CCF); and/or a change in a QoS requirement from the UE side and/or the network side.

Network-side aspects of radio bearer configuration and associated operation as may be expected in some embodiments are now discussed. In some cases, the network may configure/reconfigure a radio bearer ID and any associated PDCP, RLC, and/or MAC entity configurations corresponding to QoS requirements of a given sub-cluster (where the sub-cluster belongs to the cluster for the UE and uses a same single protocol stack architecture from the UE side, as discussed elsewhere herein). The network may communicate the configured/reconfigured radio bearer IDs to a UE via RRC messaging. A PDCP entity may route traffic to the RLC entity that corresponds to a given sub-cluster based on the radio bearer ID.

UE-side aspects of radio bearer configuration and associated operation as may be expected in some embodiments are now discussed. A UE may configure its protocol stack based on received radio bearer configuration information (including establishing any corresponding PDCP, RLC, and MAC entities for each radio bearer that corresponds to a given sub-cluster (where the sub-cluster belongs to the cluster for the UE). The PDCP entity may route traffic to an RLC entity that corresponds to a given sub-cluster based on the radio bearer ID.

A CCF may be able to either directly or indirectly exchange messages with all base station(s) belonging to a cluster via an appropriate interface. It may be that the CCF is able to either directly or indirectly exchange messages with the UE served by a cluster via an appropriate interface. It may be assumed that all base stations that belong to the cluster are able to exchange messages among themselves using, for example, Xn interface(s). It may be that the UE supports the application/use of an RRC connection with the network and is not dependent on any one connection with any particular base station. It may therefore accordingly be that a cluster and/or sub-cluster update procedure does not require the use of any RRC connection reestablishment mechanism.

Corresponding to embodiments discussed herein, there may be various types of messages that are used between the CCF, the base station(s), and the UE to perform dynamic coordination, communication, and processing of radio bearer configuration procedures.

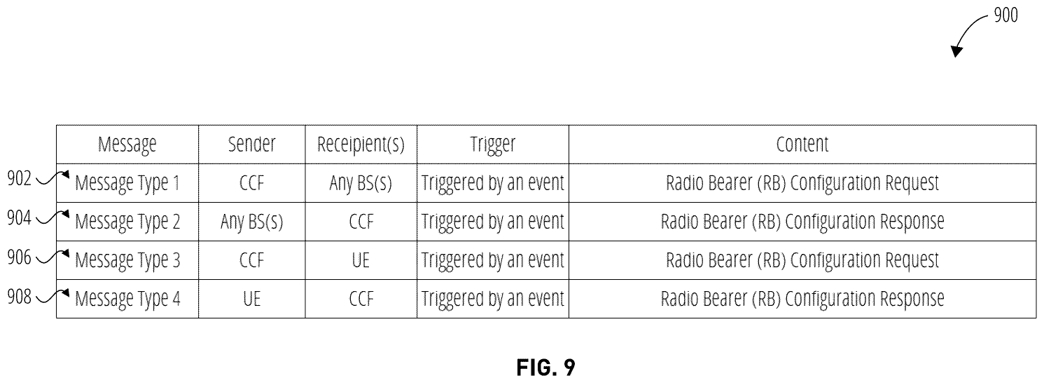

FIG. 9 illustrates a table 900 illustrating various examples of messaging that may be exchanged for cluster partitioning, according to embodiments discussed herein. The table 900 illustrates a first message type 902 that may be used. As illustrated, the first message type 902 may be sent by a CCF and received by any base station within a cluster. The first message type 902 may be triggered by an event. The first message type 902 may include a radio bearer configuration request.

For a given updated sub-clustering decision by the CCF, messages of the first message type 902 may be used by the CCF to request any base stations(s) to configure for use of a radio bearer ID and to configure the associated PDCP, RLC, and MAC entities accordingly. Messages of the first message type 902 may be triggered based on a pre-configured event (such as, for example, a clustering update, a cluster partitioning update, and/or a QoS requirement change). Messages of the first message type 902 may be sent to any base station that belongs to an applicable sub-cluster within a cluster. Messages of the first message type 902 may include any one or more of the following contents: a request ID that identifies the radio bearer configuration request; a cluster ID for the cluster in question; a sub-cluster ID for the sub-cluster in question; a radio bearer ID assignment; PDCP, RLC, and/or MAC entity configuration(s); an RLC entity and RLC buffer synchronization requirement (for cases of sub-clusters having multiple base stations); a PDCP data routing operational mode (for cases of sub-clusters having multiple base stations); and/or UE context information, which may include any one or more of a variety of items (e.g., a UE RRC status, a UE RRM configuration indicating various UE inactive times, a QoS flow to DRB mapping, information about UE capabilities for different RAT(s), an RLC buffer status report for the UE corresponding to an active time, PDU session information, and/or and network slice information).

The table 900 further illustrates a second message type 904 that may be used. As illustrated, the second message type 904 may be sent by a base station within a cluster and received by the CCF. The second message type 904 may be triggered by an event. The second message type 904 may include a radio bearer configuration response that is provided to the CCF in reply to a radio bearer configuration request received at the base station.

For a given updated sub-clustering decision by the CCF, messages of the second message type 904 may be used by base stations to respond to a request from a CCF to configure their radio bearer ID with associated PDCP, RLC, and MAC entities (e.g., in response to a message of the first message type 902 from the CCF). Messages of the second message type 904 may be triggered based on a pre-configured event (such as, for example, a clustering update, a cluster partitioning update, and/or a QoS requirement change). Messages of the second message type 904 may be sent to CCF. Messages of the second message type 904 may include any one or more of the following contents: a request ID that identifies the corresponding radio bearer configuration request; a cluster ID for the cluster in question; a sub-cluster ID for the sub-cluster in question; a radio bearer ID Assignment Response (acknowledgment); a PDCP, RLC, and/or MAC entity(s) configuration response (acknowledgment); an RLC entity and RLC buffer synchronization response (acknowledgment) (for cases of sub-clusters having multiple base stations); and/or a PDCP data routing operational mode response (acknowledgment) (for cases of sub-clusters having multiple base stations).

The table 900 further illustrates a third message type 906 that may be used. As illustrated, the third message type 906 may be sent by a CCF and received by a UE. The third message type 906 may be triggered by an event. The third message type 906 may include a radio bearer configuration request.

For a given updated sub-clustering decision by the CCF, messages of the third message type 906 may be used by the CCF to request a UE to configure for use of a radio bearer ID and to configure the associated PDCP, RLC, and MAC entities accordingly. Messages of the third message type 906 may be triggered based on a pre-configured event (such as, for example, a clustering update, a cluster partitioning update, and/or a QoS requirement change). Messages of the third message type 906 may be sent to a UE that is connected to/through an applicable sub-cluster within a cluster. Messages of the third message type 906 may include any one or more of the following contents: a request ID that identifies the radio bearer configuration request; a cluster ID for the cluster in question; a sub-cluster ID for the sub-cluster in question; a radio bearer ID assignment; PDCP, RLC, and/or MAC entity configuration(s); an RLC entity and RLC buffer synchronization requirement (for cases of sub-clusters having multiple base stations); a PDCP data routing operational mode (for cases of sub-clusters having multiple base stations); and/or UE context information, which may include any one or more of a variety of items (e.g., a UE RRC status, a UE RRM configuration indicating various UE inactive times, a QoS flow to DRB mapping, information about UE capabilities for different RAT(s), an RLC buffer status report for the UE corresponding to an active time, PDU session information, and/or and network slice information).

The table 900 further illustrates a fourth message type 908 that may be used. As illustrated, the fourth message type 908 may be sent by a UE and received by the CCF. The fourth message type 908 may be triggered by an event. The fourth message type 908 may include a radio bearer configuration response that is provided to the CCF in reply to a radio bearer configuration request received at the UE.

For a given updated sub-clustering decision by the CCF, messages of the fourth message type 908 may be used by UEs to respond to a request from a CCF to configure a radio bearer ID with associated PDCP, RLC, and MAC entities (e.g., in response to a message of the third message type 906 from the CCF). Messages of the fourth message type 908 may be triggered based on a pre-configured event (such as, for example, a clustering update, a cluster partitioning update, and/or a QoS requirement change). Messages of the fourth message type 908 may be sent to a CCF. Messages of the fourth message type 908 may include any one or more of the following contents: a request ID that identifies the corresponding radio bearer configuration request; a cluster ID for the cluster in question; a sub-cluster ID for the sub-cluster in question; a radio bearer ID assignment response (acknowledgment); a PDCP, RLC, and/or MAC entity(s) configuration response (acknowledgment); an RLC entity and RLC buffer synchronization response (acknowledgment) (for cases of sub-clusters having multiple base stations); and/or a PDCP data routing operational mode response (acknowledgment) (for cases of sub-clusters having multiple base stations).

### Example Radio Bearer Configuration Message Types Flow

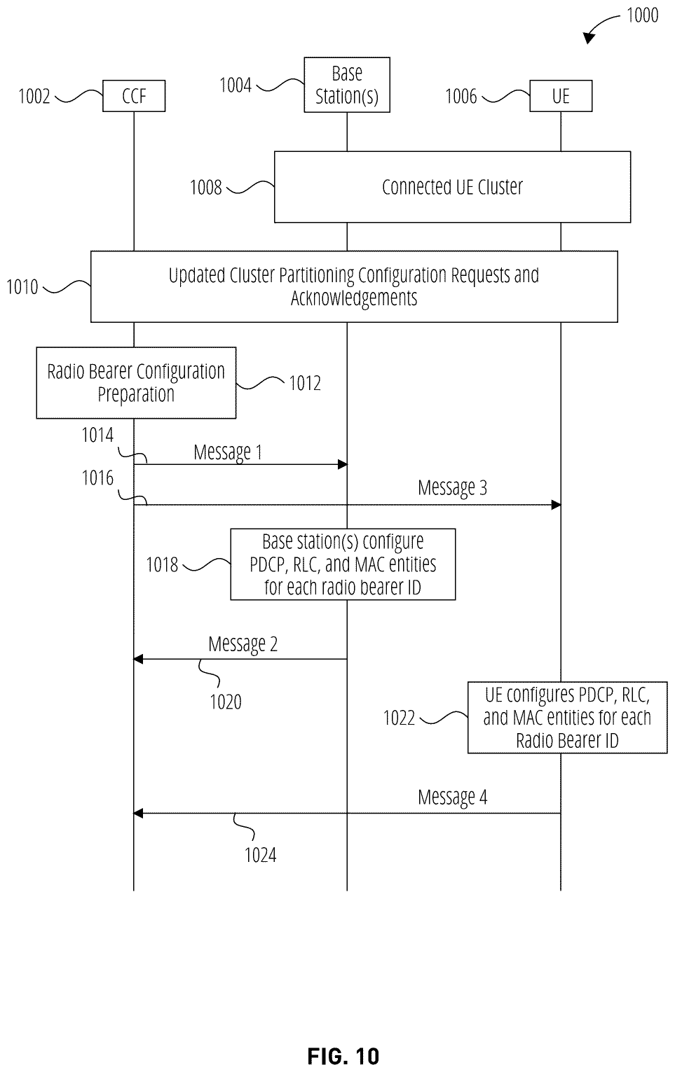

FIG. 10 illustrates a flow diagram 1000 for elements of a radio bearer configuration procedure, according to embodiments discussed herein. The flow diagram 1000 illustrates communications between a CCF 1002, base station(s) 1004, and a UE 1006.

The beginning of the flow diagram 100 corresponds to a state where a connected UE cluster 1008 exists. For example, it may be that the CCF 1002 has already formulated a cluster for the UE 1006 made up of the base station(s) 1004.

Then, updated cluster partitioning configuration requests and acknowledgements 1010 occur within the system. Accordingly, at this stage, a cluster partitioning of one or more sub-clusters made up of various ones of the base station(s) 1004 is now defined/now exists between the network and the UE 1006, according to embodiments discussed herein.

In response to the updated cluster partitioning configuration requests and acknowledgements 1010, radio bearer configuration is to be performed. Accordingly, the CCF 1002 performs radio bearer configuration preparation 1012, as illustrated.

The CCF 1002 then sends message(s) 1014 of the first message type to the base station(s) 1004, as illustrated. These message(s) 1014 request each of the base stations to, for example, configure for use of a radio bearer ID and to configure the associated PDCP, RLC, and MAC entities accordingly, per the determination(s) made during the radio bearer configuration preparation 1012.

The CCF 1002 further sends message(s) 1016 of the third message type to the UE 1006, as illustrated. These message(s) 1016 request the UE 1006 to configure for use of a radio bearer ID and to configure the associated PDCP, RLC, and MAC entities accordingly, per the determination(s) made during the radio bearer configuration preparation 1012.

In response to the message(s) 1014, the base station(s) 1004 configure 1018 PDCP, RLC, and MAC entities of the radio bearer consistent with the information provided in the message(s) 1014. The base station(s) 1004 then send the CCF 1002 message(s) 1020 of the second message type. These message(s) 1020 may acknowledge to the CCF message(s) 1020 that the respective base stations have configured PDCP, RLC, and MAC entities of the radio bearer consistent with the information provided in the message(s) 1014.

In response to the message(s) 1016, the UE 1006 configures 1022 PDCP, RLC, and MAC entities of the radio bearer consistent with the information provided in the message(s) 1014. The UE then sends the CCF 1002 message(s) 1024 of the fourth message type. These message(s) 1024 may acknowledge to the CCF 1002 that the UE 1006 has configured PDCP, RLC, and MAC entities of the radio bearer consistent with the information provided in the message(s) 1014.

### Cell-Aware and Cell-Agnostic Radio Protocol Architectures

FIG. 11 illustrates an example of a cell-agnostic radio protocol architecture 1102 and an example of a cell-aware radio protocol architecture 1104. The use of a sub-cluster based UE cluster architecture as corresponding to each of the cell-agnostic radio protocol architecture 1102 and the cell-aware radio protocol architecture 1104 are now described.

The cell-agnostic radio protocol architecture 1102 may be defined as a cluster for a UE that constitutes a single sub-cluster, as illustrated. Under the cell-agnostic radio protocol architecture 1102, the whole cluster structure may be transparent to the UE (as the UE may understand this structure with respect to the single sub-cluster). In some embodiments, the cell-agnostic radio protocol architecture 1102 may be limited to a single base station transmission/reception at a given moment of time.

The cell-aware radio protocol architecture 1104 may be defined as an architecture where each base station of the cluster for the UE constitutes a single sub-cluster. In the cell-aware radio protocol architecture 1104 the entire cluster structure may be comprehensively visible to the UE (as the UE may understand this structure with respect to each of the sub-clusters).

### Embodiments of Cell-Agnostic Radio Protocol Architectures

In some embodiments for a cell-agnostic radio protocol architecture, various aspects may apply. For example, the cell-agnostic radio protocol architecture may use transmission/reception through a single base station at a given moment of time.

Further, under a cell-agnostic radio protocol architecture, each base station of the cluster belongs to a same single sub-cluster. Accordingly, the cluster structure may be entirely transparent to the UE.

Further, from a UE protocol perspective, the cluster may be equivalent to a single sub-cluster, meaning that the UE understands a single dedicated protocol stack for the entire cluster.

Further, each base station in the cell-agnostic cluster may use synchronized RLC entities (an identical instance of an RLC entity is used at multiple base stations and/or a coordinated use of a single RLC entity instance between multiple base stations) and/or identical RLC buffer statuses, etc. Accordingly, it will be understood that both of/either of data communication and control plane communication may be routed through any of the base stations in the cell-agnostic cluster.

Further, a the PDCP entity may route the same data traffic (for example packets) to each of the synchronized RLC entity(s) at each base station.

A cell-agnostic radio protocol architecture may support the use of a PDCP Duplicated Packet mode.

Finally, if data is removed from any RLC entity (for any reason), information about the changes may be conveyed to all the synchronized RLC entity(s) of the base stations in the cell-agnostic cluster.

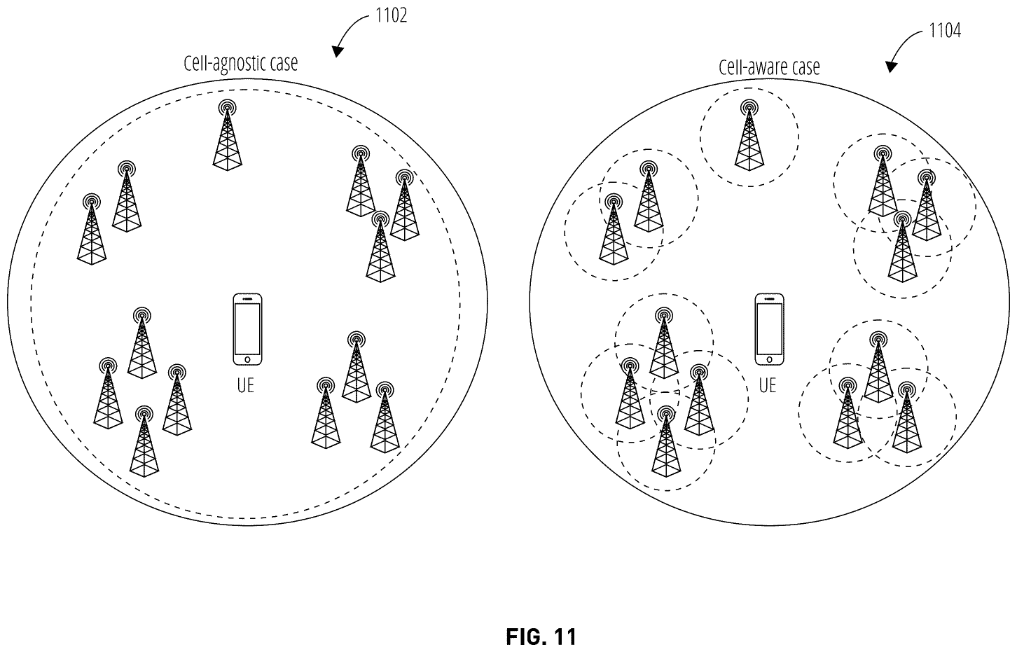

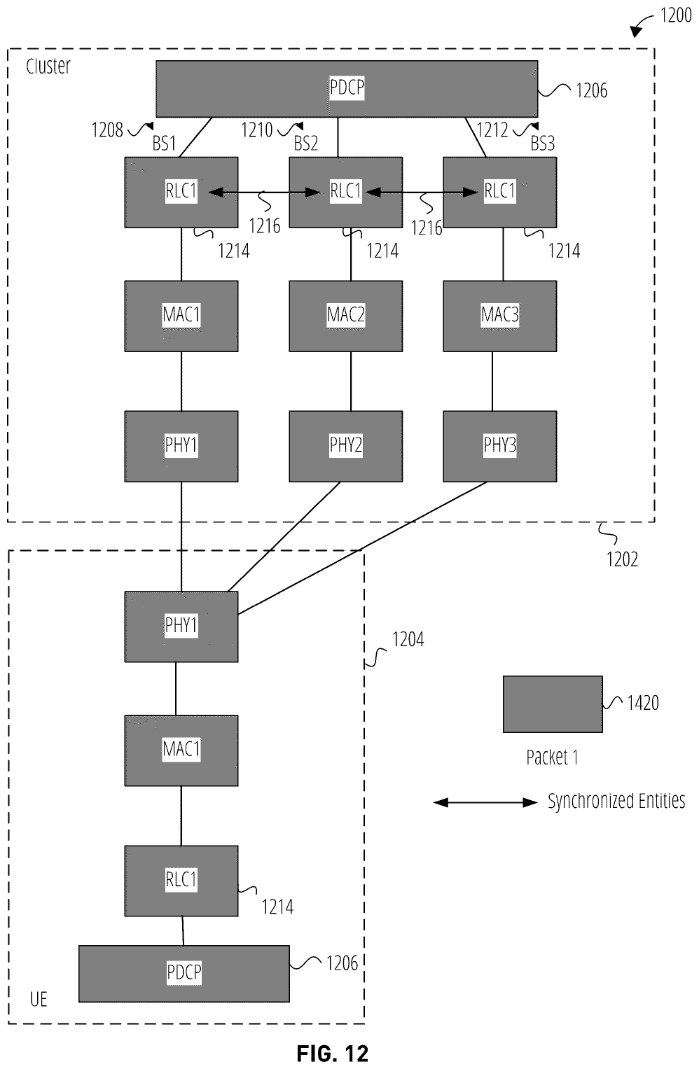

FIG. 12 illustrates an example of the use of a PDCP Duplicated Packet Mode with a radio protocol stack 1200 for a radio bearer between a cluster 1202 and a UE 1204 according to the use of sub-clustering, where the radio protocol stack 1200 is arranged according to a cell-agnostic radio protocol architecture, corresponding to embodiments discussed herein.

As illustrated, within the radio protocol stack 1200 there is a PDCP entity 1206 corresponding to the radio bearer. Beneath the PDCP entity 1206, there is a synchronized 1216 RLC entity 1214 corresponding to a first sub-cluster made up of a first base station 1208 (BS1), a second base station 1210 (BS2), and a third base station 1212 (e.g., an identical instance of an RLC entity is used at each of the first base station 1208, the second base station 1210, and the third base station 1212, and/or a coordinated use of a single RLC entity instance between the first base station 1208, the second base station 1210, and the third base station 1212 occurs). Note that the fact that all base stations of the cluster use the same synchronized RLC entity/belong to the same sub-cluster in this example corresponds to the case for a cell-agnostic radio protocol architecture under discussion.

As illustrated, identical traffic (e.g., the duplicated packet 1420) is routed through each of the first base station 1408, the second base station 1410, and the third base station 1412, corresponding to the use of the synchronized 1216 RLC entity 1214 at each of these base stations. When using same RLC entities at each of the first base station 1408, the second base station 1410, and the third base station 1412, note that the states of these RLC entities may be fully identical.

### Embodiments of Cell-Aware Radio Protocol Architectures

In some embodiments for a cell-aware radio protocol architecture, various aspects may apply. For example, under a cell-aware radio protocol architecture, each base station of cluster constitutes a unique sub-cluster. The entire cluster structure may accordingly be visible for the UE.

Further, from the UE protocol perspective, each base station may have a dedicated protocol stack.

Further, for each sub-cluster (each base station) in the cluster, there is no requirement to use have synchronized RLC entities (where an identical instance of an RLC entity is used at multiple base stations and/or a coordinated use of a single RLC entity instance between multiple base stations) and/or identical RLC buffer statuses, etc.

Further, for each sub-cluster (each base station) in the cluster, a PDCP entity is not required to route the same data traffic (packets) to the RLC entities of the various sub-clusters (the various base stations). Further, the PDCP may be configured to duplicate traffic for one sub-cluster (base station) to other sub-cluster(s) (base station(s)) of the cluster, in either DL and/or UL. A cell-aware radio protocol architecture may support either/both the use of a PDCP Duplicated Packet Mode and/or a PDCP Distinguished Packet Mode.

Finally, in cases where data is removed from any RLC entity (for any reason), information about the changes may not be conveyed to all other RLC entities of the base stations in the cell-aware cluster.

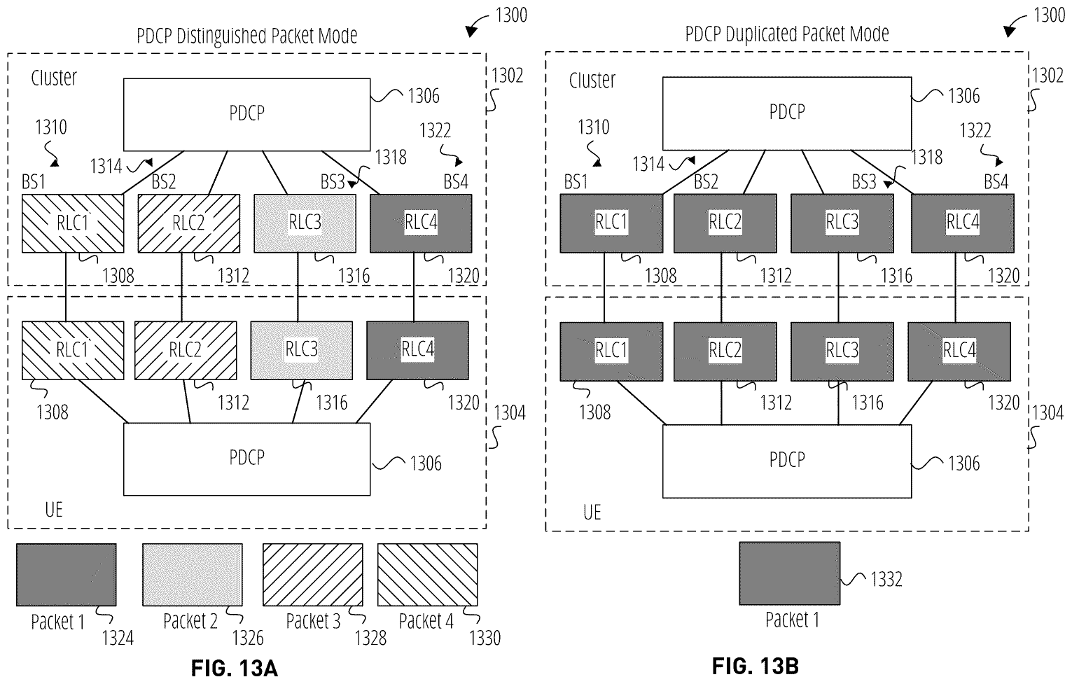

FIG. 13A illustrates an example of the use of a PDCP Distinguished Packet Mode with a radio protocol stack 1300 for a radio bearer between a cluster 1302 and a UE 1304 according to the use of sub-clustering, where the radio protocol stack 1300 is arranged according to a cell-aware radio protocol architecture, corresponding to embodiments discussed herein.

As illustrated, within the radio protocol stack 1300 there is a PDCP entity 1306 corresponding to the radio bearer. Beneath the PDCP entity 1306, there is a first RLC entity 1308 corresponding to a first sub-cluster made up of a first base station 810 (BS1), a second RLC entity 1312 corresponding to a second sub-cluster made up of a second base station 1314 (BS2), and a third RLC entity 1316 corresponding to a third sub-cluster made up of a third base station 1318, an a fourth first RLC entity 1308 corresponding to a fourth sub-cluster made up of a fourth base station 528. Note that the 1:1 relationship between RLC entity/sub-cluster and base station in this example corresponds to the case for a cell-aware radio protocol architecture under discussion.

FIG. 13A illustrates to the transport of a first unique packet 1324, a second unique packet 1326, a third unique packet 1328, and a fourth unique packet 1330 through the radio protocol stack 1300 according to a PDCP Distinguished Packet Mode. Accordingly, as illustrated, the first unique packet 1324 is routed through the first RLC entity 1308 corresponding to the first sub-cluster made up of the first base station 1310, the second unique packet 1326 is routed to/through the second RLC entity 1312 corresponding to the second sub-cluster made up of the second base station 1314, the third unique packet 1328 is routed to/through the third RLC entity 1316 corresponding to the third sub-cluster made up of the third base station 1318, and the fourth unique packet 1330 is routed to/through the fourth RLC entity 1320 corresponding to a fourth sub-cluster made up of the fourth base station 1322.

FIG. 13B illustrates an example of the use of a PDCP Duplicated Packet Mode with the radio protocol stack 1300 that is arranged according to the cell-aware radio protocol architecture. FIG. 13B illustrates the transport of a duplicated packet 1332 through the radio protocol stack 1300 according to a PDCP Duplicated Packet Mode. Accordingly, as illustrated, the duplicated packet 1332 is routed through each of the first RLC entity 1308 corresponding to the first sub-cluster made up of the first base station 1310, the second RLC entity 1312 corresponding to the second sub-cluster made up of the second base station 1314, the third RLC entity 1316 corresponding to the third sub-cluster made up of the third base station 1318, and the fourth RLC entity 1320 corresponding to a fourth sub-cluster made up of the fourth base station 1322.

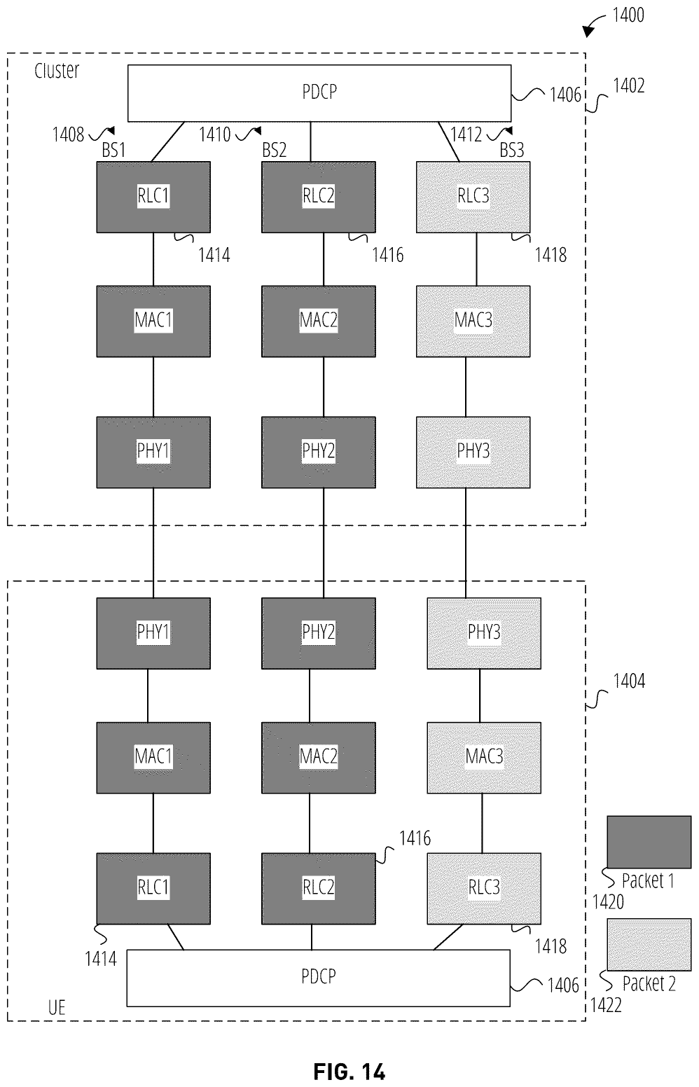

FIG. 14 illustrates an example of packet routing though a radio protocol stack 1400 for a radio bearer between a cluster 1402 and a UE 1404 according to the use of sub-clustering, where the radio protocol stack 1400 is arranged according to a cell-aware radio protocol architecture, corresponding to embodiments discussed herein. The example illustrates a case that is other than the examples for PDCP Distinguished Packet Mode and PDCP Duplicated Packet Mode with a radio protocol stack that is arranged according to a cell-aware radio protocol architecture, as previously discussed.

As illustrated, within the radio protocol stack 1400 there is a PDCP entity 1406 corresponding to the radio bearer. Beneath the PDCP entity 1406, there is a first RLC entity 1414 corresponding to a first sub-cluster made up of a first base station 1408 (BS1), a second RLC entity 1416 corresponding to a second sub-cluster made up of a second base station 1410 (BS2), and a third RLC entity 1418 corresponding to a third sub-cluster made up of a third base station 1412. Note that the 1:1 relationship between RLC entity/sub-cluster and base station in this example corresponds to the case for a cell-aware radio protocol architecture under discussion.

As illustrated, the duplicated packet 1420 is duplicated and routed through each of the first RLC entity 1414 corresponding to the first sub-cluster made up of the first base station 1408 and the second RLC entity 1416 corresponding to the second sub-cluster made up of the second base station 1410. Further, the second packet 1422 is routed through the third RLC entity 1418 corresponding to the third sub-cluster made up of the third base station 1412.

This example illustrates that first base station 1408 and the second base station 1410 may receive the same traffic as duplicated in both of the base stations, even when the states of the first RLC entity 1414 (used at the first base station 1408) and the second RLC entity 1416 (used at the second base station 1410) (e.g., RLC buffers thereof) may not be fully identical/are not synchronized.

### Embodiments for an RLC Entity for a Sub-Cluster

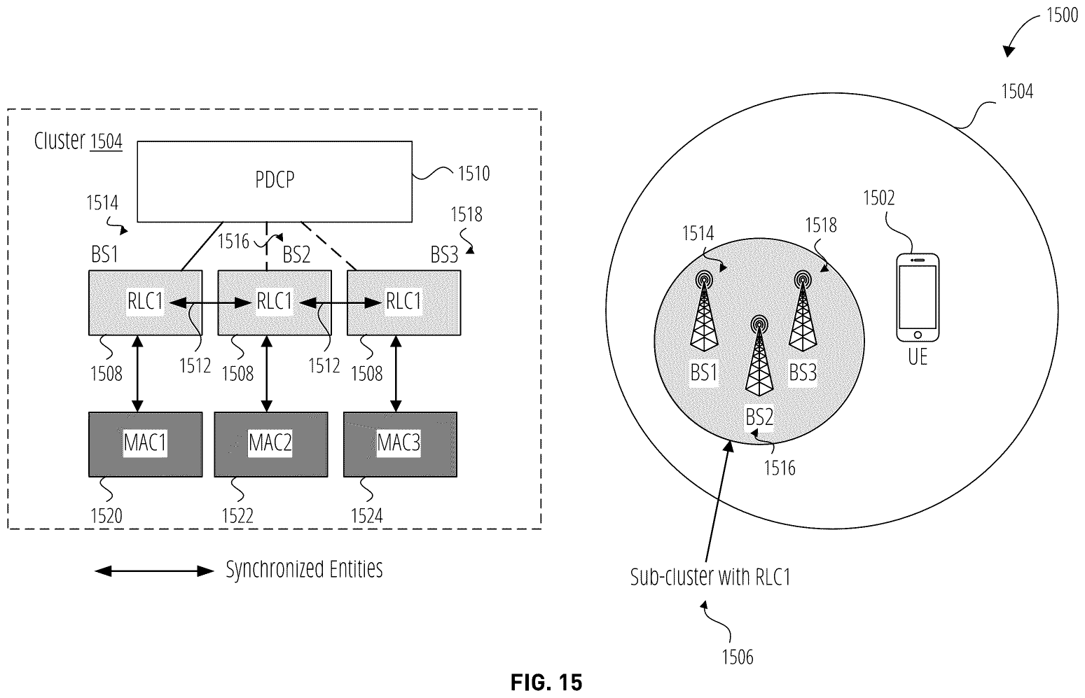

FIG. 15 illustrates a diagram 1500 showing aspects of radio protocol use in cell-free network mechanisms, according to embodiments discussed herein. A UE 1502 is served by a cluster 1504. Within the cluster 1504, there is a sub-cluster 1506 that corresponds to an RLC entity 1508 used between the UE 1502 and the cluster 1504. The RLC entity 1508 is an RLC entity used by a PDCP entity 1510 that corresponds to a radio bearer between the UE 1502 and the cluster 1504 and that uses the illustrated cluster partitioning. As illustrated, the RLC entity 1508 is synchronized 1512 across the first base station 1514, the second base station 1516, and the third base station 1518 that make up the sub-cluster 1506.

For various embodiments discussed herein, various implementation options for an RLC entity of a sub-cluster may be considered. In some cases, base stations within a same sub-cluster may share the same logical RLC entity, with each instance of the RLC entity at each base station using the same RLC ID and/or the same RLC operation modes. In this case, a base station may be able to receive an up-to-date copy of the RLC entity from another base station at any moment of time. Note that in such cases the RLC entity is considered to be synchronized across the base stations.

In some such cases, it may be that a current instance of the RLC entity (including the data buffer) may be physically located at one of the base stations in the sub-cluster.

FIG. 15 illustrates that the RLC entity 1508 is synchronized 1512 across the first base station 1514, the second base station 1516, and the third base station 1518. FIG. 15 illustrates a case where the RLC entity 1508 physically exists at the first base station 1514 (compare the use of a solid line from the representation of the RLC entity 1508 at the first base station 1514 to the use of a dotted line from the representations of the RLC entity 1508 at each of the second base station 1516 and the third base station 1518).

In such cases, when a PDCP entity routs data to an RLC entity, it may physically transfer data packets to the base station where the RLC entity is physically located. Accordingly, in the example of FIG. 15, the PDCP entity 1510 routes data packets to the first base station 1514.

In such cases, each base station in the sub-cluster may use its own MAC entity. The example shown in FIG. 15 illustrates that the first base station 1514 uses a first MAC entity 1520, the second base station 1516 uses a second MAC entity 1522, and the RLC entity 1508 uses a third MAC entity 1524.

Then, if a MAC entity of one base station where the RLC entity is not physically located requests data from the RLC entity, the data may be provided from either the base station where the RLC entity is physically located, or a copy of the RLC (including a current buffer) is transferred to the base station of the requesting MAC entity for this use. In the example of FIG. 15, if the second MAC entity 1522 of the second base station 1516 or the third MAC entity 1524 of the third base station 1518 requests data from the RLC entity 1508, the data may be either provided by the first base station 1514 to the requesting one of the second base station 1516 and the third base station 1518 as requested, or a copy of the RLC entity 1508 (including the current buffer) is transferred to the requesting one of the second base station 1516 and the third base station 1518.

In some embodiments, decisions about updating, synchronization, and/or creation of copies/instances of RLC entities and about physical placement of RLC entities may be left to network implementation.

### Embodiments of Sub-Clustering Algorithms

In one example of sub-clustering algorithms, a radio-bearer-specific (e.g., DRB-specific) procedure may be used to provide a partition of a cluster of a UE into a family of non-overlapping subsets. Each subset accordingly corresponds to an RLC entity used for that radio bearer within that cluster.

Inputs to the network for the procedure may include one or more of:
C: a list of base stations that belong to the cluster for the UE;
Xn latencies of each pair of base stations in the cluster C; and

$$L : C \times C \to {ℝ}_{\geq 0}$$

Inputs to the UE for the procedure may include one or more of:
a list of DRBs, where each DRB may be represented by the structure (DRB_ID; Delay Budget) (where Delay Budget is a non-negative value [symbol] _{≥0}); and
RLCₘₐₓ, indicating a maximum number of RLCs per DRB.

Parameters used as part of the procedure may include a latency offset parameter defined as:

ϵ∈ [symbol] _{θ0}.

Outputs of the procedure may include a list of RLC entities. Each RLC entity in the list may be represented by an RLC ID, an ID of the DRB to which it belongs, and a list of base station IDs to which the RLC entity is related is related, e.g. {RLC_ID, DRB_ID, (BS ID(s))}.

Under such circumstances, the RLC entity may be understood to belong to a single DRB. Then, for a given DRB, each base station is understood to belong to an RLC entity of this DRB.

To describe an example algorithm, a sub-routine Opt_Color_Solver(W, K) is provided. In this Opt_Color_Solver(W, K) subroutine K represents the number of colors, and W represents the matrix of edge weights in some graph.

The size of square matrix W may be the number of vertices in the graph, and wᵢⱼ≥0 may be the weight of the edge between vertices i and j. If there is no edge in the graph, wᵢⱼ=0 may be used.

The Opt_Color_Solver (W, K) subroutine outputs the optimal solution corresponding to an achieved value of a graph coloring problem where the number of colors may be fixed (equal to K), and where the coloring minimizes the sum of the weights of the edges that connect the vertices of the same color.

Mathematically, such coloring may be defined as:

$${y}_{ic} := \{ \begin{matrix}1 , if verticei is colored in c , \\ 0 , otherwise .\end{matrix}$$

The procedure Opt_Color_Solver(W, K) may output a minimum value F of a target function, and the coloring y^{opt} which provides this value.

The coloring problem may be formulated as:

$${\sum }_{i < j} {w}_{ij} \cdot {y}_{ic} \cdot {y}_{jc} \to {min}_{y} ;$$

$${\sum }_{c} {y}_{ic} = 1 , ∀ i - vertices of graph ;$$

$${y}_{i , c} ∈ \{ 0 , 1 \} , ∀ i , c ;$$

and
y:=(y_{ic})_{i,c}_{^{−}} matrix that describes the coloring.

Then, for base stations in a cluster C, a matrix of Xn latencies

(L_{i,j})_{i,j}

is considered. Iterations for applicable DRBs are traversed. For each DRB d:
L (d) is understood as the delay budget of DRB d;
A matrix of weights W is created as:

$${w}_{i , j} := \{ \begin{matrix}{L}_{i , j} , if {L}_{i , j} > L ( d ) - ε \\ 0 , otherwise\end{matrix} ;$$

K is set to 1;
the procedure Opt_Color_Solver (W, K) is executed to obtain F and y^{opt}. The execution of Opt_Color_Solver (W, K) loops while (K<RLC_max and F>0), with each loop performing K: =K+1 and a solve operation on Opt_Color_Solver (W, K) to obtain F and y^{opt};
P(d) is set as the partitioning of the cluster C, defined by y^{opt}; and
a list of RLCs for DRB d is created based on P(d).

Once complete, the procedure outputs a list of RLC entity(s).

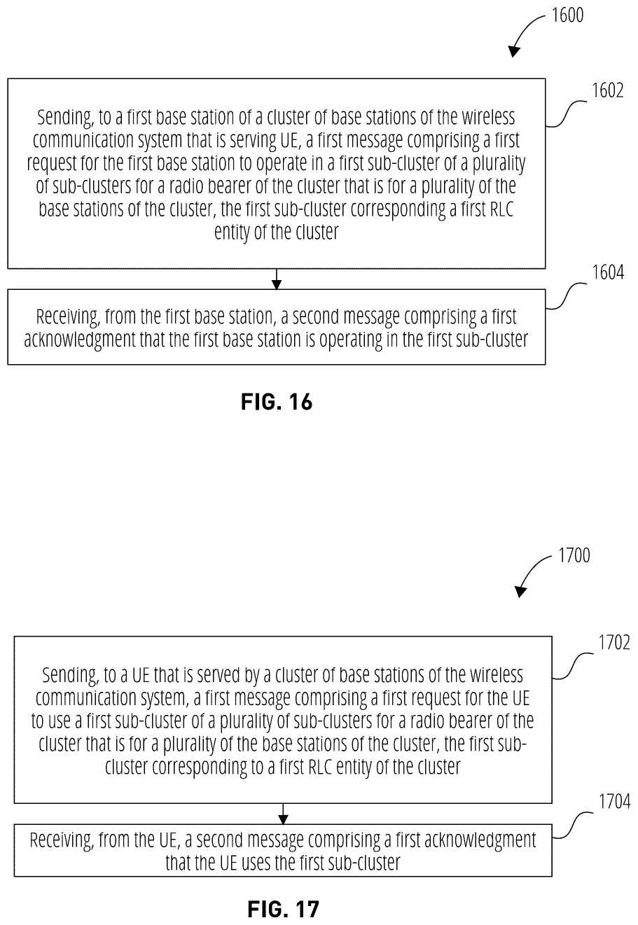

FIG. 16 illustrates a method 1600 of a CCF of a wireless communication system, according to embodiments discussed herein. The method 1600 includes sending 1602, to a first base station of a cluster of base stations of the wireless communication system that is serving a UE, a first message comprising a first request for the first base station to operate in a first sub-cluster of a plurality of sub-clusters for a radio bearer of the cluster that is for a plurality of the base stations of the cluster, the first sub-cluster corresponding a first RLC entity of the cluster.

The method 1600 further includes receiving 1604, from the first base station, a second message comprising a first acknowledgment that the first base station is operating in the first sub-cluster.

In some embodiments, the method 1600 further includes sending, to a second base station of the cluster, a third message comprising a second request for the second base station to operate in the first sub-cluster; and receiving, from the second base station, a fourth message comprising a second acknowledgment that the second base station is operating in the first sub-cluster.

In some embodiments, the method 1600 further includes sending, to a second base station of the cluster, a third message comprising a second instruction for the second base station to operate in a second sub-cluster of the plurality of sub-clusters for the radio bearer, the second sub-cluster corresponding to a second RLC entity of the cluster; and receiving, from the second base station, a fourth message comprising a second acknowledgment that the second base station is operating in the second sub-cluster.

In some embodiments of the method 1600, the first message further comprises an identifier for the first request.

In some embodiments of the method 1600, the first message further comprises an identifier for the cluster.

In some embodiments of the method 1600, the first message further comprises an identifier for the first sub-cluster.

In some embodiments of the method 1600, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 1600, the second message further comprises an identifier for the first request.

In some embodiments of the method 1600, the second message further comprises an identifier for the cluster.

In some embodiments of the method 1600, the second message further comprises an identifier for the first sub-cluster.

FIG. 17 illustrates a method 1700 of a CCF of a wireless communication system, according to embodiments discussed herein. The method 1700 includes sending 1702, to a UE that is served by a cluster of base stations of the wireless communication system, a first message comprising a first request for the UE to use a first sub-cluster of a plurality of sub-clusters for a radio bearer of the cluster that is for a plurality of the base stations of the cluster, the first sub-cluster corresponding to a first radio link control (RLC) entity of the cluster.

The method 1700 further includes receiving 1704, from the UE, a second message comprising a first acknowledgment that the UE uses the first sub-cluster.

In some embodiments, the method 1700 further includes sending, to the UE, a third message comprising a second request for the UE to use a second sub-cluster of the plurality of sub-clusters for the radio bearer, the second sub-cluster corresponding to a second RLC entity of the cluster; and receiving, from the UE, a fourth message comprising a second acknowledgment that the UE uses the second sub-cluster.

In some embodiments of the method 1700, the first message further comprises an identifier for the first request.

In some embodiments of the method 1700, the first message further comprises an identifier for the cluster.

In some embodiments of the method 1700, the first message further comprises an identifier for the first sub-cluster.

In some embodiments of the method 1700, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 1700, the second message further comprises an identifier for the first request.

In some embodiments of the method 1700, the second message further comprises an identifier for the cluster.

In some embodiments of the method 1700, the second message further comprises an identifier for the first sub-cluster.

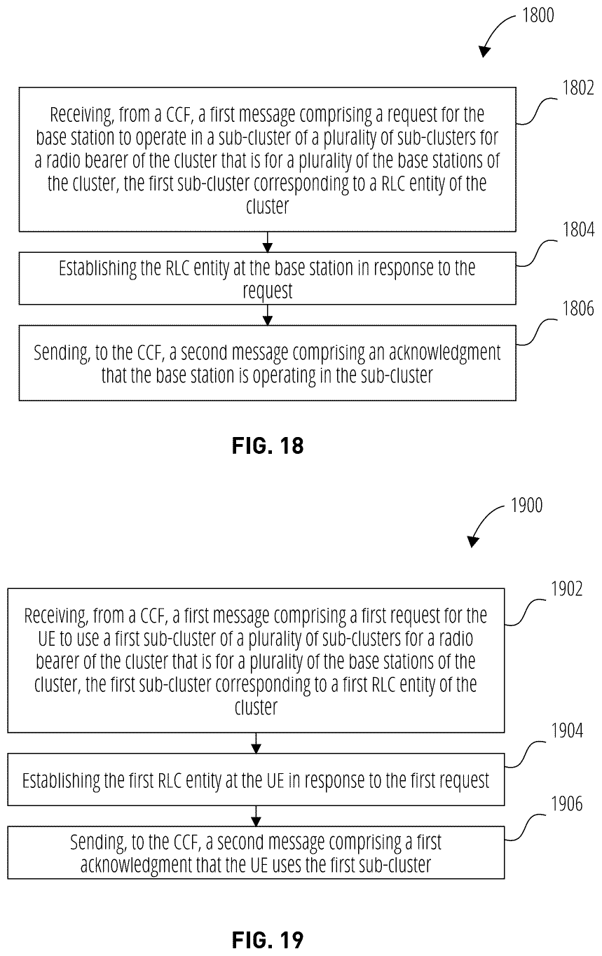

FIG. 18 illustrates a method 1800 of a base station of a cluster of base station of a wireless communication system that is serving a UE, according to embodiments discussed herein. The method 1800 includes receiving 1802, from a CCF, a first message comprising a request for the base station to operate in a sub-cluster of a plurality of sub-clusters for a radio bearer of the cluster that is for a plurality of the base stations of the cluster, the first sub-cluster corresponding to an RLC entity of the cluster.

The method 1800 further includes establishing 1804 the RLC entity at the base station in response to the request.

The method 1800 further includes sending 1806, to the CCF, a second message comprising an acknowledgment that the base station is operating in the sub-cluster.

In some embodiments of the method 1800, the first message further comprises an identifier for the request.

In some embodiments of the method 1800, the first message further comprises an identifier for the cluster.

In some embodiments of the method 1800, the first message further comprises an identifier for the sub-cluster.

In some embodiments of the method 1800, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 1800, the second message further comprises an identifier for the request.

In some embodiments of the method 1800, the second message further comprises an identifier for the cluster.

In some embodiments of the method 1800, the second message further comprises an identifier for the sub-cluster.

FIG. 19 illustrates a method 1900 of a UE served by a cluster of base stations of a wireless communication system, according to embodiments discussed herein. The method 1900 includes receiving 1902, from a CCF, a first message comprising a first request for the UE to use a first sub-cluster of a plurality of sub-clusters for a radio bearer of the cluster that is for a plurality of the base stations of the cluster, the first sub-cluster corresponding to an RLC entity of the cluster.

The method 1900 further includes establishing 1904 the first RLC entity at the UE in response to the first request.

The method 1900 further includes sending 1906, to the CCF, a second message comprising a first acknowledgment that the UE uses the first sub-cluster.

In some embodiments, the method 1900 further includes receiving, from the CCF, a third message comprising a second request for the UE to use a second sub-cluster of the plurality of sub-clusters for the radio bearer, the second sub-cluster corresponding to a second RLC entity of the cluster; establishing the second RLC entity at the UE in response to the second request; and sending, to the CCF, a fourth message comprising a second acknowledgment that the UE uses the second sub-cluster.

In some embodiments of the method 1900, the first message further comprises an identifier for the first request.

In some embodiments of the method 1900, the first message further comprises an identifier for the cluster.

In some embodiments of the method 1900, the first message further comprises an identifier for the first sub-cluster.

In some embodiments of the method 1900, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 1900, the second message further comprises an identifier for the first request.

In some embodiments of the method 1900, the second message further comprises an identifier for the cluster.

In some embodiments of the method 1900, the second message further comprises an identifier for the first sub-cluster.

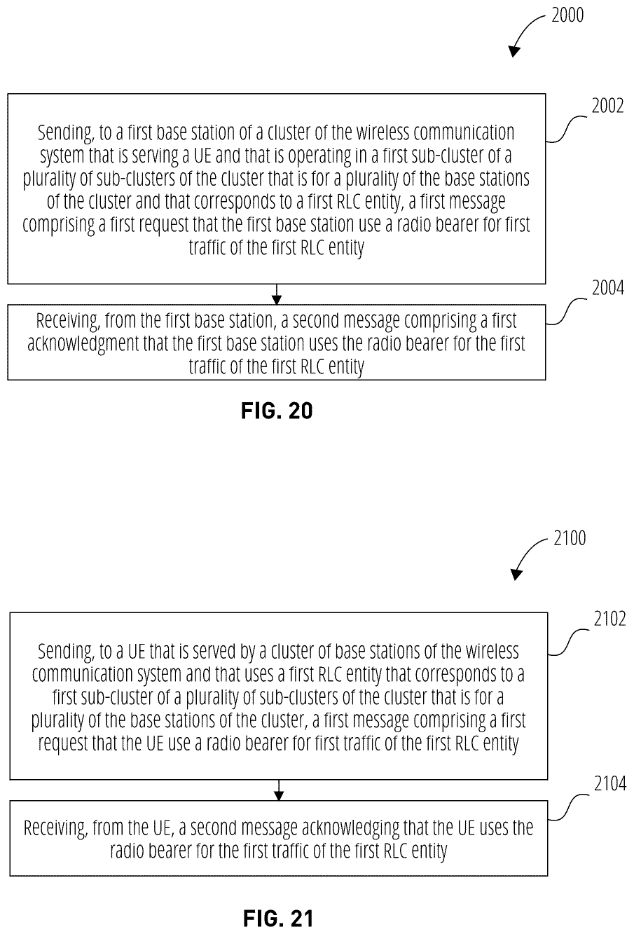

FIG. 20 illustrates a method 2000 of a CCF of a wireless communication system, according to embodiments discussed herein. The method 2000 includes sending 2002, to a first base station of a cluster of the wireless communication system that is serving a UE and that is operating in a first sub-cluster of a plurality of sub-clusters of the cluster that is for a plurality of the base stations of the cluster and that corresponds to a first RLC entity, a first message comprising a first request that the first base station use a radio bearer for first traffic of the first RLC entity.

The method 2000 further includes receiving 2004, from the first base station, a second message comprising a first acknowledgment that the first base station uses the radio bearer for the first traffic of the first RLC entity.

In some embodiments, the method 2000 further includes sending, to a second base station of the cluster that is operating in the first sub-cluster, a third message comprising a second request that the second base station use the radio bearer for the first traffic of the first RLC entity; and receiving, from the second base station, a fourth message comprising a second acknowledgment that the second base station uses the radio bearer for the first traffic of the first RLC entity.

In some embodiments, the method 2000 further includes sending, to a second base station of the cluster that is operating in a second sub-cluster of the plurality of sub-clusters of the cluster that corresponds to a second RLC entity, a third message comprising a second request that the second base station use the radio bearer for second traffic of the second RLC entity; and receiving, from the second base station, a fourth message comprising a second acknowledgment that the second base station uses the radio bearer for the second traffic of the second RLC entity.

In some embodiments of the method 2000, the first message further comprises an identifier for the first request.

In some embodiments of the method 2000, the first message further comprises an identifier for the cluster.

In some embodiments of the method 2000, the first message further comprises an identifier for the first sub-cluster.

In some embodiments of the method 2000, the first message further comprises an identifier for the radio bearer.

In some embodiments of the method 2000, the first message further comprises configuration information for one or more of: a PDCP entity; the first RLC entity; and a MAC entity.

In some embodiments of the method 2000, the first message further comprises an RLC buffer synchronization requirement.

In some embodiments of the method 2000, the first message further comprises a PDCP routing operational mode indication.

In some embodiments of the method 2000, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 2000, the second message further comprises an identifier for the first request.

In some embodiments of the method 2000, the second message further comprises an identifier for the cluster.

In some embodiments of the method 2000, the second message further comprises an identifier for the first sub-cluster.

In some embodiments of the method 2000, the second message further comprises a second acknowledgment of configuration information for one or more of: a (PDCP entity; the first RLC entity; and a MAC entity.

In some embodiments of the method 2000, the second message further comprises a second acknowledgement of an RLC buffer synchronization requirement.

In some embodiments of the method 2000, the second message further indicates a second acknowledgement of a PDCP routing operational mode.

FIG. 21 illustrates a method 2100 of a CCF of a wireless communication system, according to embodiments discussed herein. The method 2100 includes sending 2102, to a UE that is served by a cluster of base stations of the wireless communication system and that uses a first RLC entity that corresponds to a first sub-cluster of a plurality of sub-clusters of the cluster that is for a plurality of the base stations of the cluster, a first message comprising a first request that the UE use a radio bearer for first traffic of the first RLC entity.

The method 2100 further includes receiving 2104, from the UE, a second message acknowledging that the UE uses the radio bearer for the first traffic of the first RLC entity.

In some embodiments of the method 2100, the UE further uses a second RLC entity that corresponds to a second sub-cluster of the plurality of sub-clusters of the cluster, and the method 2100 further includes: sending, to the UE, a third message comprising a second request for the UE to use the radio bearer for second traffic of the second RLC entity; and receiving, from the UE, a fourth message acknowledging that the UE uses the radio bearer for the second traffic of the second RLC entity.

In some embodiments of the method 2100, the first message further comprises an identifier for the first request.

In some embodiments of the method 2100, the first message further comprises an identifier for the cluster.

In some embodiments of the method 2100, the first message further comprises an identifier for the first sub-cluster.

In some embodiments of the method 2100, the first message further comprises an identifier for the first radio bearer.

In some embodiments of the method 2100, the first message further comprises configuration information for one or more of: a PDCP entity; the first RLC entity; and a MAC entity.

In some embodiments of the method 2100, the first message further comprises an RLC buffer synchronization requirement.

In some embodiments of the method 2100, the first message further comprises a PDCP routing operational mode indication.

In some embodiments of the method 2100, the first message further comprises one or more of: a RRC status of the UE; a RRM configuration for the UE; QoS flow to DRB mapping information; RAT capability information for the UE; an RLC buffer status report for the UE; PDU session information; and network slicing information.

In some embodiments of the method 2100, the second message further comprises an identifier for the first request.

In some embodiments of the method 2100, the second message further comprises an identifier for the cluster.

In some embodiments of the method 2100, the second message further comprises an identifier for the first sub-cluster.

In some embodiments of the method 2100, the second message further comprises a second acknowledgment of configuration information for one or more of: a PDCP entity; the first RLC entity; and a MAC entity.

In some embodiments of the method 2100, the second message further comprises a second acknowledgement of an RLC buffer synchronization requirement.

In some embodiments of the method 2100, the second message further indicates a second acknowledgement of a PDCP routing operational mode.

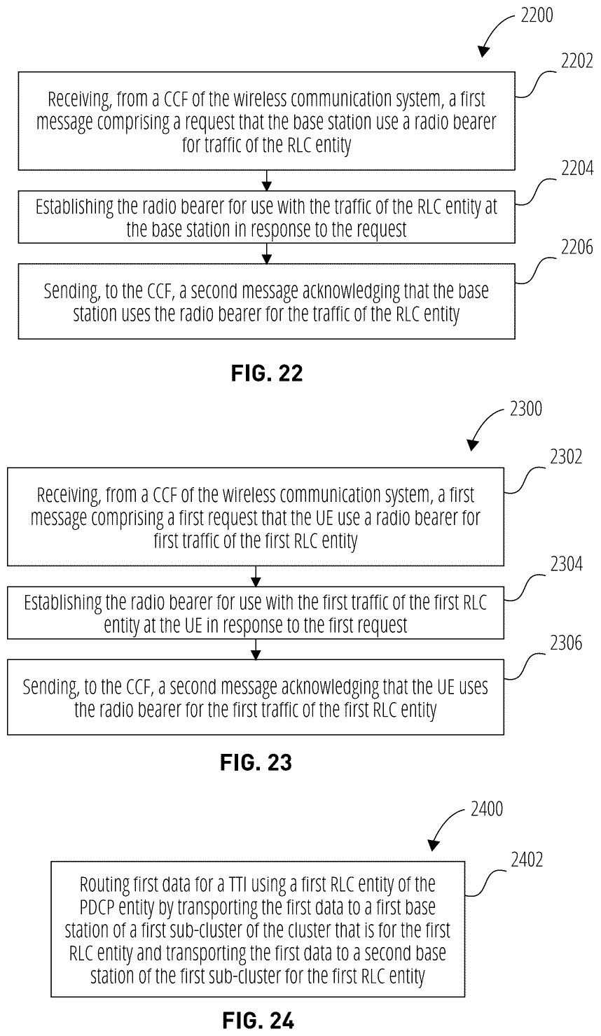

FIG. 22 illustrates a method 2200 of a base station of a cluster of base stations of a wireless communication system that is serving a UE and that is operating in a first sub-cluster of a plurality of sub-clusters of the cluster that is for a plurality of the base stations of the cluster and that corresponds to a first RLC entity, according to embodiments discussed herein. The method 2200 includes receiving 2202, from a CCF of the wireless communication system, a first message comprising a request that the base station use a radio bearer for traffic of the RLC entity.

The method 2200 further includes establishing 2204 the radio bearer for use with the traffic of the RLC entity at the base station in response to the request.

The method 2200 further includes sending 2206, to the CCF, a second message acknowledging that the base station uses the radio bearer for the traffic of the RLC entity.

In some embodiments of the method 2200, the first message further comprises an identifier for the request.

In some embodiments of the method 2200, the first message further comprises an identifier for the cluster.

In some embodiments of the method 2200, the first message further comprises an identifier for the first sub-cluster.

In some embodiments of the method 2200, the first message further comprises an identifier for the radio bearer.

In some embodiments of the method 2200, the first message further comprises configuration information for one or more of: a PDCP entity; the RLC entity; and a MAC entity.

In some embodiments of the method 2200, the first message further comprises an RLC buffer synchronization requirement.

In some embodiments of the method 2200, the first message further comprises a PDCP routing operational mode indication.

In some embodiments of the method 2200, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 2200, the second message further comprises an identifier for the request.

In some embodiments of the method 2200, the second message further comprises an identifier for the cluster.

In some embodiments of the method 2200, the second message further comprises an identifier for the first sub-cluster.

In some embodiments of the method 2200, the second message further comprises a second acknowledgment of configuration information for one or more of: a PDCP entity; the RLC entity; and a MAC entity.

In some embodiments of the method 2200, the second message further comprises a second acknowledgement of an RLC buffer synchronization requirement.

In some embodiments of the method 2200, the second message further indicates a second acknowledgement of a PDCP routing operational mode.

FIG. 23 illustrates a method 2300 of a UE served by a cluster of base stations of a wireless communication system and that uses a first RLC entity of the cluster that corresponds to a first sub-cluster of a plurality of sub-clusters of the cluster that is for a plurality of the base stations of the cluster, according to embodiments discussed herein. The method 2300 includes receiving 2302, from a CCF of the wireless communication system, a first message comprising a first request that the UE use a radio bearer for first traffic of the first RLC entity.

The method 2300 further includes establishing 2304 the radio bearer for use with the first traffic of the first RLC entity at the UE in response to the first request.

The method 2300 further includes sending 2306, to the CCF, a second message acknowledging that the UE uses the radio bearer for the first traffic of the first RLC entity.

In some embodiments of the method 2300, the UE further uses a second RLC entity of the cluster that corresponds to a second sub-cluster of the plurality of sub-clusters of the cluster, and the method 2300 further includes: receiving, from the CCF, a third message comprising a second request that the UE use a radio bearer for second traffic of the second RLC entity; establishing the radio bearer for use with the second traffic of the second RLC entity at the UE in response to the second request; and sending, to the CCF, a fourth message acknowledging that the UE uses the radio bearer for the second traffic of the second RLC entity.

In some embodiments of the method 2300, the first message further comprises an identifier for the first request.

In some embodiments of the method 2300, the first message further comprises an identifier for the cluster.

In some embodiments of the method 2300, the first message further comprises an identifier for the first sub-cluster.

In some embodiments of the method 2300, the first message further comprises an identifier for the radio bearer.

In some embodiments of the method 2300, the first message further comprises configuration information for one or more of: a PDCP entity; the first RLC entity; and a MAC entity.

In some embodiments of the method 2300, the first message further comprises an RLC buffer synchronization requirement.

In some embodiments of the method 2300, the first message further comprises a PDCP routing operational mode indication.

In some embodiments of the method 2300, the first message further comprises one or more of: an RRC status of the UE; an RRM configuration for the UE; QoS flow to DRB mapping information; RAT capability information for the UE; an RLC buffer status report for the UE; PDU session information; and network slicing information.

In some embodiments of the method 2300, the second message further comprises an identifier for the first request.

In some embodiments of the method 2300, the second message further comprises an identifier for the cluster.

In some embodiments of the method 2300, the second message further comprises an identifier for the first sub-cluster.

In some embodiments of the method 2300, the second message further comprises a second acknowledgment of configuration information for one or more of: a PDCP entity; the first RLC entity; and a MAC entity.

In some embodiments of the method 2300, the second message further comprises a second acknowledgement of an RLC buffer synchronization requirement.

In some embodiments of the method 2300, the second message further indicates a second acknowledgement of a PDCP routing operational mode.

FIG. 24 illustrates a method 2400 of a PDCP entity of a cluster of base stations serving a UE, according to embodiments discussed herein. The method 2400 includes routing 2402 first data for a transmission time interval (TTI) using a first RLC entity of the PDCP entity by transporting the first data to a first base station of a first sub-cluster of the cluster that is for the first RLC entity and transporting the first data to a second base station of the first sub-cluster for the first RLC entity.

In some embodiments, the method 2400 further includes routing the first data through a second RLC entity of the PDCP entity by transporting the first data to a third base station of a second sub-cluster of the cluster that is for the second RLC entity.

In some embodiments, the method 2400 further includes routing second data for the TTI through a second RLC entity of the PDCP entity by transporting the second data to a third base station of a second sub-cluster of the cluster that is for the second RLC entity.

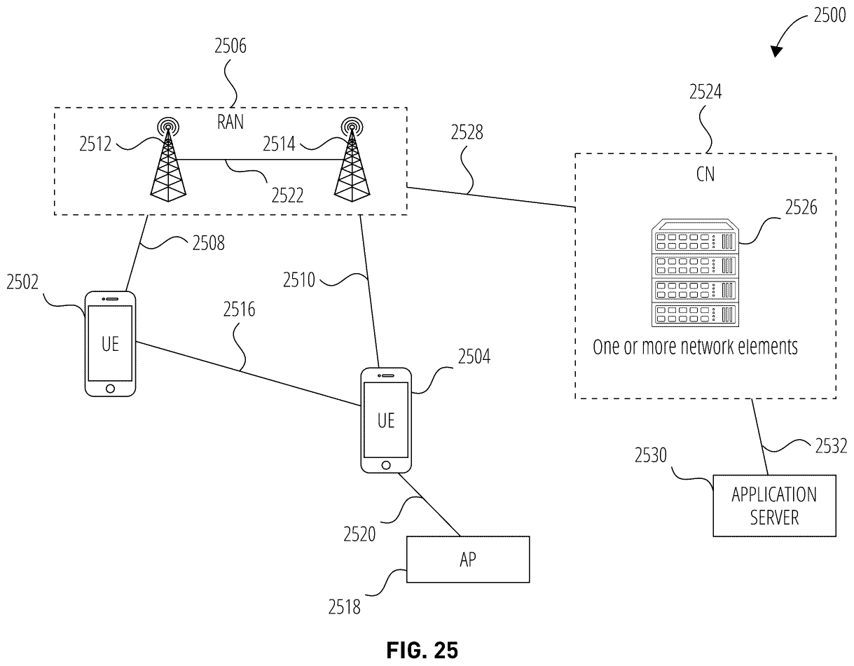

FIG. 25 illustrates an example architecture of a wireless communication system 2500, according to embodiments disclosed herein. The following description is provided for an example wireless communication system 2500 that operates in conjunction with the LTE system standards and/or 5G or NR system standards as provided by 3GPP technical specifications.

As shown by FIG. 25, the wireless communication system 2500 includes UE 2502 and UE 2504 (although any number of UEs may be used). In this example, the UE 2502 and the UE 2504 are illustrated as smartphones (e.g., handheld touchscreen mobile computing devices connectable to one or more cellular networks), but may also comprise any mobile or non-mobile computing device configured for wireless communication.

The UE 2502 and UE 2504 may be configured to communicatively couple with a RAN 2506. In embodiments, the RAN 2506 may be NG-RAN, E-UTRAN, etc. The UE 2502 and UE 2504 utilize connections (or channels) (shown as connection 2508 and connection 2510, respectively) with the RAN 2506, each of which comprises a physical communications interface. The RAN 2506 can include one or more base stations (such as base station 2512 and base station 2514) that enable the connection 2508 and connection 2510.

In this example, the connection 2508 and connection 2510 are air interfaces to enable such communicative coupling, and may be consistent with RAT(s) used by the RAN 2506, such as, for example, an LTE and/or NR.

In some embodiments, the UE 2502 and UE 2504 may also directly exchange communication data via a sidelink interface 2516. The UE 2504 is shown to be configured to access an access point (shown as AP 2518) via connection 2520. By way of example, the connection 2520 can comprise a local wireless connection, such as a connection consistent with any IEEE 802.11 protocol, wherein the AP 2518 may comprise a Wi-Fi® router. In this example, the AP 2518 may be connected to another network (for example, the Internet) without going through a CN 2524.

In embodiments, the UE 2502 and UE 2504 can be configured to communicate using orthogonal frequency division multiplexing (OFDM) communication signals with each other or with the base station 2512 and/or the base station 2514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2512 or base station 2514 may be implemented as one or more software entities running on server computers as part of a virtual network. In addition, or in other embodiments, the base station 2512 or base station 2514 may be configured to communicate with one another via interface 2522. In embodiments where the wireless communication system 2500 is an LTE system (e.g., when the CN 2524 is an EPC), the interface 2522 may be an X2 interface. The X2 interface may be defined between two or more base stations (e.g., two or more eNBs and the like) that connect to an EPC, and/or between two eNBs connecting to the EPC. In embodiments where the wireless communication system 2500 is an NR system (e.g., when CN 2524 is a 5GC), the interface 2522 may be an Xn interface. The Xn interface is defined between two or more base stations (e.g., two or more gNBs and the like) that connect to 5GC, between a base station 2512 (e.g., a gNB) connecting to 5GC and an eNB, and/or between two eNBs connecting to 5GC (e.g., CN 2524).

The RAN 2506 is shown to be communicatively coupled to the CN 2524. The CN 2524 may comprise one or more network elements 2526, which are configured to offer various data and telecommunications services to customers/subscribers (e.g., users of UE 2502 and UE 2504) who are connected to the CN 2524 via the RAN 2506. The components of the CN 2524 may be implemented in one physical device or separate physical devices including components to read and execute instructions from a machine-readable or computer-readable medium (e.g., a non-transitory machine-readable storage medium).

In embodiments, the CN 2524 may be an EPC, and the RAN 2506 may be connected with the CN 2524 via an S1 interface 2528. In embodiments, the S1 interface 2528 may be split into two parts, an S1 user plane (S1-U) interface, which carries traffic data between the base station 2512 or base station 2514 and a serving gateway (S-GW), and the S1-MME interface, which is a signaling interface between the base station 2512 or base station 2514 and mobility management entities (MMEs).

In embodiments, the CN 2524 may be a 5GC, and the RAN 2506 may be connected with the CN 2524 via an NG interface 2528. In embodiments, the NG interface 2528 may be split into two parts, an NG user plane (NG-U) interface, which carries traffic data between the base station 2512 or base station 2514 and a user plane function (UPF), and the S1 control plane (NG-C) interface, which is a signaling interface between the base station 2512 or base station 2514 and access and mobility management functions (AMFs).

Generally, an application server 2530 may be an element offering applications that use internet protocol (IP) bearer resources with the CN 2524 (e.g., packet switched data services). The application server 2530 can also be configured to support one or more communication services (e.g., VOIP sessions, group communication sessions, etc.) for the UE 2502 and UE 2504 via the CN 2524. The application server 2530 may communicate with the CN 2524 through an IP communications interface 2532.

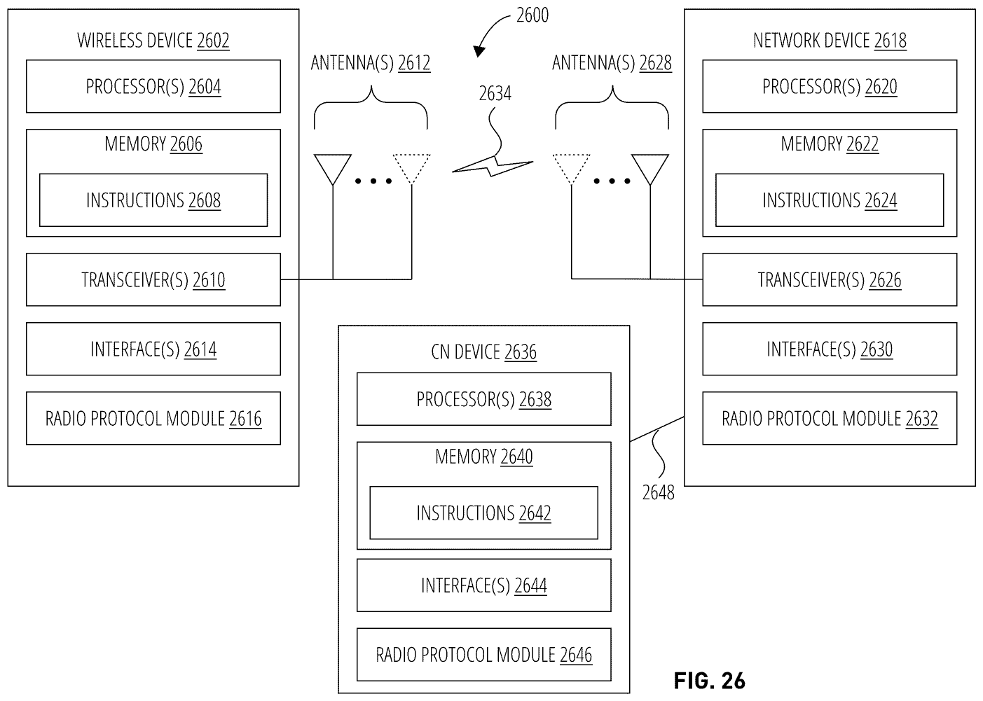

FIG. 26 illustrates a system 2600 for performing signaling 2634 between a wireless device 2602 and a network device 2618 as supported by a CN device 2636, according to embodiments disclosed herein. The system 2600 may be a portion of a wireless communications system as herein described. The wireless device 2602 may be, for example, a UE of a wireless communication system. The network device 2618 may be, for example, a base station (e.g., an eNB, a gNB, or a sixth generation base station) of a wireless communication system.

The wireless device 2602 may include one or more processor(s) 2604. The processor(s) 2604 may execute instructions such that various operations of the wireless device 2602 are performed, as described herein. The processor(s) 2604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2602 may include a memory 2606. The memory 2606 may be a non-transitory computer-readable storage medium that stores instructions 2608 (which may include, for example, the instructions being executed by the processor(s) 2604). The instructions 2608 may also be referred to as program code or a computer program. The memory 2606 may also store data used by, and results computed by, the processor(s) 2604.

The wireless device 2602 may include one or more transceiver(s) 2610 that may include radio frequency (RF) transmitter circuitry and/or receiver circuitry that use the antenna(s) 2612 of the wireless device 2602 to facilitate signaling (e.g., the signaling 2634) to and/or from the wireless device 2602 with other devices (e.g., the network device 2618) according to corresponding RATs.

The wireless device 2602 may include one or more antenna(s) 2612 (e.g., one, two, four, or more). For embodiments with multiple antenna(s) 2612, the wireless device 2602 may leverage the spatial diversity of such multiple antenna(s) 2612 to send and/or receive multiple different data streams on the same time and frequency resources. This behavior may be referred to as, for example, multiple input multiple output MIMO behavior (referring to the multiple antennas used at each of a transmitting device and a receiving device that enable this aspect). MIMO transmissions by the wireless device 2602 may be accomplished according to precoding (or digital beamforming) that is applied at the wireless device 2602 that multiplexes the data streams across the antenna(s) 2612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2602 may implement analog beamforming techniques, whereby phases of the signals sent by the antenna(s) 2612 are relatively adjusted such that the (joint) transmission of the antenna(s) 2612 can be directed (this is sometimes referred to as beam steering).

The wireless device 2602 may include one or more interface(s) 2614. The interface(s) 2614 may be used to provide input to or output from the wireless device 2602. For example, a wireless device 2602 that is a UE may include interface(s) 2614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2610/antenna(s) 2612 already described) that allow for communication between the UE and other devices and may operate according to known protocols (e.g., Wi-Fi®, Bluetooth®, and the like).

The wireless device 2602 may include a radio protocol module 2616. The radio protocol module 2616 may be implemented via hardware, software, or combinations thereof. For example, the radio protocol module 2616 may be implemented as a processor, circuit, and/or instructions 2608 stored in the memory 2606 and executed by the processor(s) 2604. In some examples, the radio protocol module 2616 may be integrated within the processor(s) 2604 and/or the transceiver(s) 2610. For example, the radio protocol module 2616 may be implemented by a combination of software components (e.g., executed by a DSP or a general processor) and hardware components (e.g., logic gates and circuitry) within the processor(s) 2604 or the transceiver(s) 2610.

The radio protocol module 2616 may be used for various aspects of the present disclosure, for example, aspects of FIG. 1 through FIG. 24. For example, the radio protocol module 2616 may be used to receive and/or send messages corresponding to sub-clustering and/or to receive and/or send messages corresponding to radio bearer assignment, as discussed herein.

The network device 2618 may include one or more processor(s) 2620. The processor(s) 2620 may execute instructions such that various operations of the network device 2618 are performed, as described herein. The processor(s) 2620 may include one or more baseband processors implemented using, for example, a CPU, a DSP, an ASIC, a controller, an FPGA device, another hardware device, a firmware device, or any combination thereof configured to perform the operations described herein.

The network device 2618 may include a memory 2622. The memory 2622 may be a non-transitory computer-readable storage medium that stores instructions 2624 (which may include, for example, the instructions being executed by the processor(s) 2620). The instructions 2624 may also be referred to as program code or a computer program. The memory 2622 may also store data used by, and results computed by, the processor(s) 2620.

The network device 2618 may include one or more transceiver(s) 2626 that may include RF transmitter circuitry and/or receiver circuitry that use the antenna(s) 2628 of the network device 2618 to facilitate signaling (e.g., the signaling 2634) to and/or from the network device 2618 with other devices (e.g., the wireless device 2602) according to corresponding RATs.

The network device 2618 may include one or more antenna(s) 2628 (e.g., one, two, four, or more). In embodiments having multiple antenna(s) 2628, the network device 2618 may perform MIMO, digital beamforming, analog beamforming, beam steering, etc., as has been described.

The network device 2618 may include one or more interface(s) 2630. The interface(s) 2630 may be used to provide input to or output from the network device 2618. For example, a network device 2618 that is a base station may include interface(s) 2630 made up of transmitters, receivers, and other circuitry (e.g., other than the transceiver(s) 2626/antenna(s) 2628 already described) that enables the base station to communicate with other equipment in a core network, and/or that enables the base station to communicate with external networks, computers, databases, and the like for purposes of operations, administration, and maintenance of the base station or other equipment operably connected thereto. As another example, the network device 2618 may communicate with the CN device 2636 on an interface 2648 of the interface(s) 2630 (which, in, for example, NR cases, may be an NG interface or in LTE cases may be an S1 interface).

The network device 2618 may include a radio protocol module 2632. The radio protocol module 2632 may be implemented via hardware, software, or combinations thereof. For example, the radio protocol module 2632 may be implemented as a processor, circuit, and/or instructions 2624 stored in the memory 2622 and executed by the processor(s) 2620. In some examples, the radio protocol module 2632 may be integrated within the processor(s) 2620 and/or the transceiver(s) 2626. For example, the radio protocol module 2632 may be implemented by a combination of software components (e.g., executed by a DSP or a general processor) and hardware components (e.g., logic gates and circuitry) within the processor(s) 2620 or the transceiver(s) 2626.

The radio protocol module 2632 may be used for various aspects of the present disclosure, for example, aspects of FIG. 1 through FIG. 24. For example, the radio protocol module 2616 may be used to receive and/or send messages corresponding to sub-clustering and/or to receive and/or send messages corresponding to radio bearer assignment, as discussed herein.

The CN device 2636 may include one or more 2638. The processor(s) 2638 may execute instructions such that various operations of the CN device 2636 are performed, as described herein. The processor(s) 2638 may include one or more baseband processors implemented using, for example, a CPU, a DSP, an ASIC, a controller, an FPGA device, another hardware device, a firmware device, or any combination thereof configured to perform the operations described herein.

The CN device 2636 may include a memory 2640. The memory 2640 may be a non-transitory computer-readable storage medium that stores instructions 2642 (which may include, for example, the instructions being executed by the processor(s) 2638). The instructions 2642 may also be referred to as program code or a computer program. The memory 2640 may also store data used by, and results computed by, the processor(s) 2638.

The CN device 2636 may include one or more interface(s) 2644. The interface(s) 2644 may be used to provide input to or output from the CN device 2636. For example, a CN device 2636 may communicate with the network device 2618 on an interface 2648 of the interface(s) 2644 (which, in, for example, NR cases, may be an NG interface or in LTE cases may be an S1 interface).

The CN device 2636 may include a radio protocol module 2646. The radio protocol module 2646 may be implemented via hardware, software, or combinations thereof. For example, the radio protocol module 2646 may be implemented as a processor, circuit, and/or instructions 2642 stored in the memory 2640 and executed by the processor(s) 2638. In some examples, the radio protocol module 2646 may be integrated within the processor(s) 2638. For example, the radio protocol module 2646 may be implemented by a combination of software components (e.g., executed by a DSP or a general processor) and hardware components (e.g., logic gates and circuitry) within the processor(s) 2604.

The radio protocol module 2646 may be used for various aspects of the present disclosure, for example, aspects of FIG. 1 through FIG. 24. For example, the radio protocol module 2616 may be used to receive and/or send messages corresponding to sub-clustering and/or to receive and/or send messages corresponding to radio bearer assignment, as discussed herein.

Embodiments contemplated herein include an apparatus comprising means to perform one or more elements of any of the method 1900 and the method 2300. This apparatus may be, for example, an apparatus of a UE (such as a wireless device 2602 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 1900 and the method 2300. This non-transitory computer-readable media may be, for example, a memory of a UE (such as a memory 2606 of a wireless device 2602 that is a UE, as described herein).

Embodiments contemplated herein include an apparatus comprising logic, modules, or circuitry to perform one or more elements of any of the method 1900 and the method 2300. This apparatus may be, for example, an apparatus of a UE (such as a wireless device 2602 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 1900 and the method 2300. This apparatus may be, for example, an apparatus of a UE (such as a wireless device 2602 that is a UE, as described herein).

Embodiments contemplated herein include a signal as described in or related to one or more elements of any of the method 1900 and the method 2300.

Embodiments contemplated herein include a computer program or computer program product comprising instructions, wherein execution of the program by a processor is to cause the processor to carry out one or more elements of any of the method 1900 and the method 2300. The processor may be a processor of a UE (such as a processor(s) 2604 of a wireless device 2602 that is a UE, as described herein). These instructions may be, for example, located in the processor and/or on a memory of the UE (such as a memory 2606 of a wireless device 2602 that is a UE, as described herein).

Embodiments contemplated herein include an apparatus comprising means to perform one or more elements of any of the method 1800 and the method 2200. This apparatus may be, for example, an apparatus of a base station (such as a network device 2618 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1800 and the method 2200. This non-transitory computer-readable media may be, for example, a memory of a base station (such as a memory 2622 of a network device 2618 that is a base station, as described herein).

Embodiments contemplated herein include an apparatus comprising logic, modules, or circuitry to perform one or more elements of any of the method 1800 and the method 2200. This apparatus may be, for example, an apparatus of a base station (such as a network device 2618 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1800 and the method 2200. This apparatus may be, for example, an apparatus of a base station (such as a network device 2618 that is a base station, as described herein).

Embodiments contemplated herein include a signal as described in or related to one or more elements of any of the method 1800 and the method 2200.

Embodiments contemplated herein include a computer program or computer program product comprising instructions, wherein execution of the program by a processing element is to cause the processing element to carry out one or more elements of any of the method 1800 and the method 2200. The processor may be a processor of a base station (such as a processor(s) 2620 of a network device 2618 that is a base station, as described herein). These instructions may be, for example, located in the processor and/or on a memory of the base station (such as a memory 2622 of a network device 2618 that is a base station, as described herein).

Embodiments contemplated herein include an apparatus comprising means to perform one or more elements of any of the method 1600, the method 1700, the method 2000, and the method 2100. This apparatus may be, for example, an apparatus of a base station (such as a network device 2618 that is a base station, as described herein) and/or of a CN. It is further contemplated that this apparatus may be one of many such apparatuses working together in a distributed fashion to perform the one or more elements of any of the method 1600, the method 1700, the method 2000, and the method 2100.

Embodiments contemplated herein include one or more non-transitory computer-readable media comprising instructions to cause an electronic device, upon execution of the instructions by one or more processors of the electronic device, to perform one or more elements of any of the method 1600, the method 1700, the method 2000, and the method 2100. This non-transitory computer-readable media may be, for example, a memory of a base station (such as a memory 2622 of a network device 2618 that is a base station, as described herein) and/or of a CN. It is further contemplated that the electronic device may be one of many such electronic devices working together in a distributed fashion to perform the one or more elements of any of the method 1600, the method 1700, the method 2000, and the method 2100.

Embodiments contemplated herein include an apparatus comprising logic, modules, or circuitry to perform one or more elements of any of the method 1600, the method 1700, the method 2000, and the method 2100. This apparatus may be, for example, an apparatus of a base station (such as a network device 2618 that is a base station, as described herein) and/or of a CN. It is further contemplated that this apparatus may be one of many such apparatuses working together in a distributed fashion to perform the one or more elements of any of the method 1600, the method 1700, the method 2000, and the method 2100.

Embodiments contemplated herein include an apparatus comprising: one or more processors and one or more computer-readable media comprising instructions that, when executed by the one or more processors, cause the one or more processors to perform one or more elements of any of the method 1600, the method 1700, the method 2000, and the method 2100. This apparatus may be, for example, an apparatus of a base station (such as a network device 2618 that is a base station, as described herein) and/or of a CN. It is further contemplated that this apparatus may be one of many such apparatuses working together in a distributed fashion to perform the one or more elements of any of the method 1600, the method 1700, the method 2000, and the method 2100.

Embodiments contemplated herein include a signal as described in or related to one or more elements of any of the method 1600, the method 1700, the method 2000, and the method 2100.

Embodiments contemplated herein include a computer program or computer program product comprising instructions, wherein execution of the program by a processing element is to cause the processing element to carry out one or more elements of any of the method 1600, the method 1700, the method 2000, and the method 2100. The processor may be a processor of a base station (such as a processor(s) 2620 of a network device 2618 that is a base station, as described herein). These instructions may be, for example, located in the processor and/or on a memory of the base station (such as a memory 2622 of a network device 2618 that is a base station, as described herein) and/or a CN. These instructions may be, for example, located in the processor and/or on a memory of the base station (such as a memory 2622 of a network device 2618 that is a base station, as described herein) and/or the CN. It is further contemplated that the processing element may be one of many such processing elements working together in a distributed fashion to perform the one or more elements of any of the method 1600, the method 1700, the method 2000, and the method 2100.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a clustering control function (CCF) of a wireless communication system, comprising:
sending, to a user equipment (UE) that is served by a cluster of base stations of the wireless communication system and that uses a first radio link control (RLC) entity that corresponds to a first sub-cluster of a plurality of sub-clusters of the cluster that is for a plurality of the base stations of the cluster, a first message comprising a first request that the UE use a radio bearer for first traffic of the first RLC entity; and
receiving, from the UE, a second message acknowledging that the UE uses the radio bearer for the first traffic of the first RLC entity.

2. The method of claim 1, wherein the UE further uses a second RLC entity that corresponds to a second sub-cluster of the plurality of sub-clusters of the cluster, and further comprising:
sending, to the UE, a third message comprising a second request for the UE to use the radio bearer for second traffic of the second RLC entity; and
receiving, from the UE, a fourth message acknowledging that the UE uses the radio bearer for the second traffic of the second RLC entity.

3. The method of claim 1, wherein the first message further comprises an identifier for the first request.

4. The method of claim 1, wherein the first message further comprises configuration information for one or more of:
a packet data convergence protocol (PDCP) entity;
the first RLC entity; and
a medium access control (MAC) entity.

5. The method of claim 1, wherein the first message further comprises an RLC buffer synchronization requirement.

6. The method of claim 1, wherein the first message further comprises a packet data convergence protocol (PDCP) routing operational mode indication.

7. The method of claim 1, wherein the first message further comprises one or more of:
a radio resource control (RRC) status of the UE;
a radio resource management (RRM) configuration for the UE;
quality of service (QOS) flow to data radio bearer (DRB) mapping information;
radio access technology (RAT) capability information for the UE;
an RLC buffer status report for the UE;
protocol data unit (PDU) session information; and
network slicing information.

8. A method of a base station of a cluster of base stations of a wireless communication system that is serving a user equipment (UE) and that is operating in a first sub-cluster of a plurality of sub-clusters of the cluster that is for a plurality of the base stations of the cluster and that corresponds to a first radio link control (RLC) entity, comprising:
receiving, from a clustering control function (CCF) of the wireless communication system, a first message comprising a request that the base station use a radio bearer for traffic of the RLC entity;
establishing the radio bearer for use with the traffic of the RLC entity at the base station in response to the request; and
sending, to the CCF, a second message acknowledging that the base station uses the radio bearer for the traffic of the RLC entity.

9. The method of claim 8, wherein the first message further comprises an identifier for the request.

10. The method of claim 8, wherein the first message further comprises an RLC buffer synchronization requirement.

11. The method of claim 8, wherein the first message further comprises a packet data convergence protocol (PDCP) routing operational mode indication.

12. The method of claim 8, wherein the second message further comprises a second acknowledgement of an RLC buffer synchronization requirement.

13. The method of claim 8, wherein the second message further indicates a second acknowledgement of a packet data convergence protocol (PDCP) routing operational mode.

14. A method of a user equipment (UE) served by a cluster of base stations of a wireless communication system and that uses a first radio link control (RLC) entity of the cluster that corresponds to a first sub-cluster of a plurality of sub-clusters of the cluster that is for a plurality of the base stations of the cluster, comprising:
receiving, from a clustering control function (CCF) of the wireless communication system, a first message comprising a first request that the UE use a radio bearer for first traffic of the first RLC entity;
establishing the radio bearer for use with the first traffic of the first RLC entity at the UE in response to the first request; and
sending, to the CCF, a second message acknowledging that the UE uses the radio bearer for the first traffic of the first RLC entity.

15. The method of claim 14, wherein the UE further uses a second RLC entity of the cluster that corresponds to a second sub-cluster of the plurality of sub-clusters of the cluster, and further comprising:
receiving, from the CCF, a third message comprising a second request that the UE use a radio bearer for second traffic of the second RLC entity;
establishing the radio bearer for use with the second traffic of the second RLC entity at the UE in response to the second request; and
sending, to the CCF, a fourth message acknowledging that the UE uses the radio bearer for the second traffic of the second RLC entity.

16. The method of claim 14, wherein the second message further comprises an identifier for the cluster.

17. The method of claim 14, wherein the second message further comprises an identifier for the first sub-cluster.

18. The method of claim 14, wherein the second message further comprises a second acknowledgment of configuration information for one or more of:
a packet data convergence protocol (PDCP) entity;
the first RLC entity; and
a medium access control (MAC) entity.

19. The method of claim 14, wherein the second message further comprises a second acknowledgement of an RLC buffer synchronization requirement.

20. The method of claim 14, wherein the second message further indicates a second acknowledgement of a packet data convergence protocol (PDCP) routing operational mode.
